(19) United States
(12) Patent Application Publication
(10) Pub. No.: US 2014/0043821 A1
(43) Pub. Date: Feb. 13, 2014

(54) LED BULB HAVING A UNIFORM LIGHT-DISTRIBUTION PROFILE

(71) Applicants: Matrika Bhattarai, San Jose, CA (US); Ronan Le Toquin, Fremont, CA (US); David Horn, Saratoga, CA (US); Robert Edward Shroder, Tucson, AZ (US); Robert Joseph Pagano, Tucson, AZ (US)

(72) Inventors: Matrika Bhattarai, San Jose, CA (US); Ronan Le Toquin, Fremont, CA (US); David Horn, Saratoga, CA (US); Robert Edward Shroder, Tucson, AZ (US); Robert Joseph Pagano, Tucson, AZ (US)

(73) Assignee: Switch Bulb Company, Inc., San Jose, CA (US)

(21) Appl. No.: 13/588,964

(22) Filed: Aug. 17, 2012

Related U.S. Application Data
(60) Provisional application No. 61/681,123, filed on Aug. 8, 2012.

(51) Int. Cl. F21V 3/02; G06F 17/50; F21V 3/04

(52) U.S. Cl. CPC F21V 3/02; F21V 3/049; G06F 17/5009
USPC 362/294; 362/373; 29/825; 703/2

(57) ABSTRACT

An LED bulb includes a base, a shell, a plurality of LEDs, and a thermally conductive liquid. The shell is connected to the base. The plurality of LEDs is attached to the base and disposed within the shell. The thermally conductive liquid is held within the shell. The LED bulb is configured to produce a uniform light-distribution profile.

### CROSS REFERENCE TO RELATED APPLICATIONS

This application claims the benefit under 35 USC 119(e) of prior copending U.S. Provisional Patent Application No. 61/681,123, filed Aug. 8, 2012, the disclosure of which is hereby incorporated by reference in its entirety.

### BACKGROUND

1. Field

The present disclosure relates generally to liquid-cooled light emitting diode (LED) bulbs and, more specifically, to techniques for producing an LED bulb having a uniform light-distribution profile.

2. Related Art

Traditionally, lighting has been generated using fluorescent and incandescent light bulbs. While both types of light bulbs have been reliably used, each suffers from certain drawbacks. For instance, incandescent bulbs tend to be inefficient, using only 2-3% of their power to produce light, while the remaining 97-98% of their power is lost as heat. Fluorescent bulbs, while more efficient than incandescent bulbs, do not produce the same warm light as that generated by incandescent bulbs. Additionally, there are health and environmental concerns regarding the mercury contained in fluorescent bulbs.

Thus, an alternative light source is desired. One such alternative is a bulb utilizing an LED. An LED comprises a semiconductor junction that emits light due to an electrical current flowing through the junction. Compared to a traditional incandescent bulb, an LED bulb is capable of producing more light using the same amount of power. Additionally, the operational life of an LED bulb is orders of magnitude longer than that of an incandescent bulb, for example, 10,000-100,000 hours as opposed to 1,000-2,000 hours.

It may be advantageous for an LED bulb to have a uniform light-distribution profile over a substantial portion of the bulb surface. For example, Energy Star specifications require that the light intensity emissions of a light bulb should not vary greater than 20 percent over an area from 0 degrees to 135 degrees, as measured from an axis from the center of the bulb through the apex of the bulb. One challenge to producing a bulb using LEDs is that the light distribution is not inherently uniform, as provided by the Energy Star specifications.

The devices and methods described herein can be used to produce an LED bulb with a light-distribution profile having improved uniformity of light distribution. In one embodiment, an LED bulb is provided with uniformity that meets Energy Star specifications.

### SUMMARY

In one exemplary embodiment, a light emitting diode (LED) bulb is provided having a light-distribution profile that satisfies uniformity criteria. An index of refraction and profile shape of a simulated shell are obtained and an index of refraction of a simulated thermally conductive liquid is obtained. An optical simulation model of an LED bulb is created. The optical simulation model having a plurality of simulated LEDs disposed within the simulated shell and the simulated thermally conductive liquid disposed between the plurality of simulated LEDs and the interior of the simulated shell. One or more of the following are calculated: an angle and a height of at least one simulated LED of the plurality of simulated LEDs with respect to the shell; a profile shape of the simulated shell, the profile shape having at least two radii; and a location of a diffuser band. The calculation is based on: the optical simulation model; the index of refraction of the simulated shell; and the index of refraction of the thermally conductive liquid. The calculation results in a predicted light-distribution profile that varies 20 percent or less with respect to mean light intensity over 0 degrees to 135 degrees as measured from an axis extending from the center of the simulated shell to the apex of the simulated shell. The results of the calculation are stored in computer memory.

### DESCRIPTION OF THE FIGURES

FIG. 1 depicts an LED bulb.

FIGS. 2A and 2B depict an LED bulb with a liquid expansion compensator.

FIG. 3A-D depict exemplary processes for an LED bulb.

FIGS. 4A-L depict analysis results for an LED bulb having various LED mounting angles and heights.

FIGS. 5A-C depict emission intensity for an LED bulb having various LED mounting angles and heights.

FIGS. 6A-C depict emission uniformity for an LED bulb having various LED mounting angles and heights.

FIGS. 7A-L depict dimensions of an LED bulb having various LED mounting angles and heights.

FIGS. 8A-B depict an LED bulb having various shell profile shapes.

FIG. 9 depicts emission uniformity for an LED bulb having various shell profile shapes.

FIG. 10 depicts an LED bulb with a diffuser band.

FIG. 11 depicts emission uniformity for an LED bulb with a diffuser band.

FIG. 12 depicts emission uniformity for an exemplary simulated LED bulb and an actual LED bulb.

FIG. 13 depicts an exemplary bidirectional reflectance distribution function for the simulated support structures and the simulated base of a simulated LED bulb.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

Various embodiments are described below, relating to LED bulbs. As used herein, an “LED bulb” refers to any light-generating device (e.g., a lamp) in which at least one LED is used to generate the light. Thus, as used herein, an “LED bulb” does not include a light-generating device in which a filament is used to generate the light, such as a conventional incandescent light bulb. It should be recognized that the LED bulb may have various shapes in addition to the bulb-like A-type shape of a conventional incandescent light bulb. For example, the bulb may have a tubular shape, globe shape, or the like. The LED bulb of the present disclosure may further include any type of connector; for example, a screw-in base, a dual-prong connector, a standard two- or three-prong wall outlet plug, bayonet base, Edison Screw base, single pin base, multiple pin base, recessed base, flanged base, grooved base, side base, or the like.

As used herein, the term “liquid” refers to a substance capable of flowing. Also, the substance used as the thermally conductive liquid is a liquid or at the liquid state within, at least, the operating temperature range of the bulb. An exemplary temperature range includes temperatures between −40° C. to +50° C. Also, as used herein, “passive convective flow” refers to the circulation of a liquid without the aid of a fan or other mechanical devices driving the flow of the thermally conductive liquid.

### 1. Liquid-Filled LED Bulb

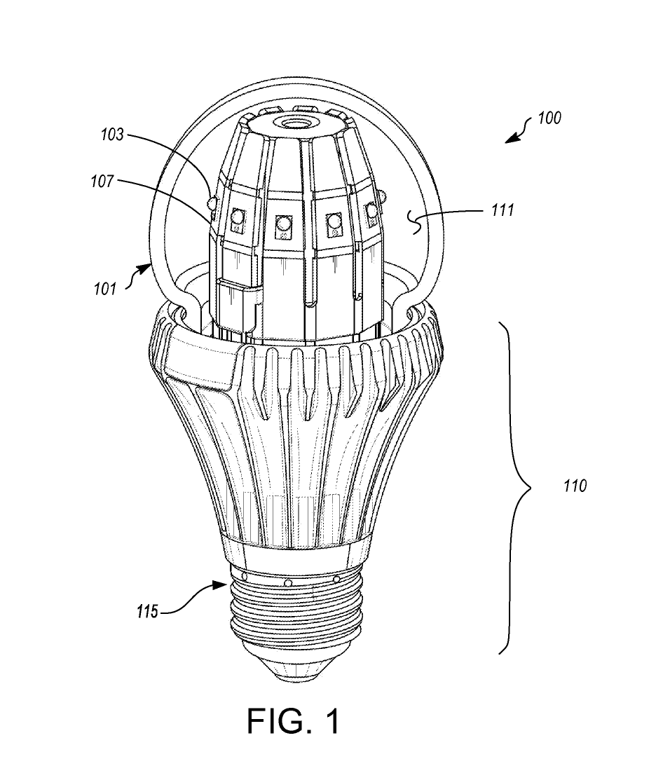

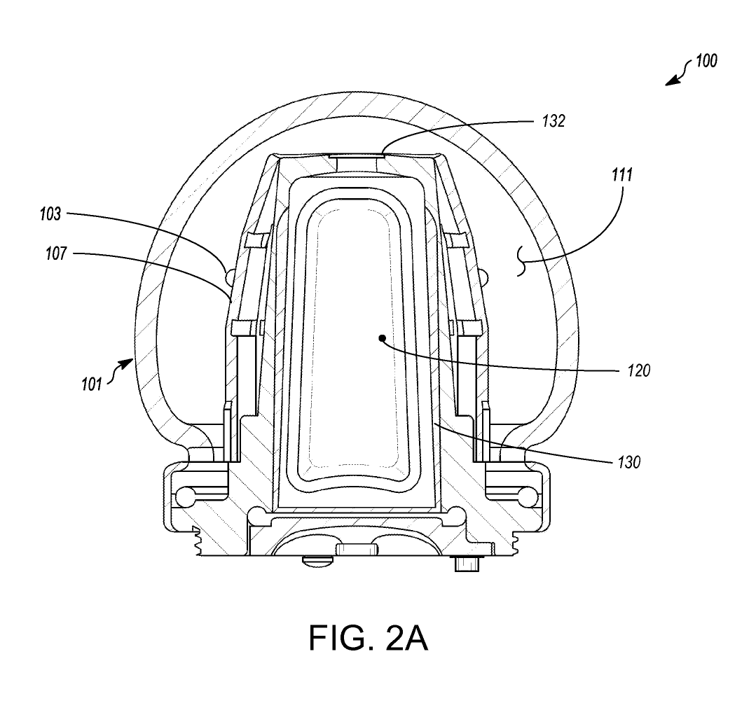

FIG. 1 depicts an exemplary liquid-filled LED bulb 100. LED bulb 100 includes a base 110 and a shell 101 encasing the various components of LED bulb 100. The shell 101 is attached to the base 110 forming an enclosed volume. An array of LEDs 103 are mounted to support structures 107 and are disposed within the enclosed volume. The enclosed volume is filled with a thermally conductive liquid 111.

For convenience, all examples provided in the present disclosure describe and show LED bulb 100 being a standard A-type form factor bulb. However, as mentioned above, it should be appreciated that the present disclosure may be applied to LED bulbs having any shape, such as a tubular bulb, globe-shaped bulb, or the like.

Shell 101 may be made from any transparent or translucent material such as plastic, glass, polycarbonate, or the like. The shell 101 may be clear or frosted to disperse light produced by the LEDs. Shell 101 has a geometric center and an apex located at the top of the LED bulb 100 as it is drawn in FIG. 1.

As noted above, light bulbs typically conform to a standard form factor, which allows bulb interchangeability between different lighting fixtures and appliances. Accordingly, in the present exemplary embodiment, LED bulb 100 includes connector base 115 for connecting the bulb to a lighting fixture. In one example, connector base 115 may be a conventional light bulb base having threads 117 for insertion into a conventional light socket. However, as noted above, it should be appreciated that connector base 115 may be any type of connector for mounting LED bulb 100 or coupling to a power source. For example, connector base may provide mounting via a screw-in base, a dual-prong connector, a standard two- or three-prong wall outlet plug, bayonet base, Edison Screw base, single pin base, multiple pin base, recessed base, flanged base, grooved base, side base, or the like.

In some embodiments, LED bulb 100 may use 6 W or more of electrical power to produce light equivalent to a 40 W incandescent bulb. In some embodiments, LED bulb 100 may use 18 W or more to produce light equivalent to or greater than a 75 W incandescent bulb. Depending on the efficiency of the LED bulb 100, between 4 W and 16 W of heat energy may be produced when the LED bulb 100 is illuminated.

The LED bulb 100 includes several components for dissipating the heat generated by LEDs 103. For example, as shown in FIG. 1, LED bulb 100 includes one or more support structures 107 for holding LEDs 103. Support structures 107 may be made of any thermally conductive material, such as aluminum, copper, brass, magnesium, zinc, or the like. In some embodiments, the support structures are made of a composite laminate material. Since support structures 107 are formed of a thermally conductive material, heat generated by LEDs 103 may be conductively transferred to support structures 107 and passed to other component of the LED bulb 100 and the surrounding environment. Thus, support structures 107 may act as a heat-sink or heat-spreader for LEDs 103.

Support structures 107 are attached to bulb base 110 allowing the heat generated by LEDs 103 to be conducted to other portions of LED bulb 100. Support structures 107 and bulb base 110 may be formed as one piece or multiple pieces. The bulb base 110 may also be made of a thermally conductive material and attached to support structures 107 so that heat generated by LED 103 is conducted into the bulb base 110 in an efficient manner. Bulb base 110 is also attached to shell 101. Bulb base 110 can also thermally conduct with shell 101.

Bulb base 110 also includes one or more components that provide the structural features for mounting bulb shell 101 and support structure 107. Components of the bulb base 110 include, for example, sealing gaskets, flanges, rings, adaptors, or the like. Bulb base 110 also includes a connector base 115 for connecting the bulb to a power source or lighting fixture. Bulb base 110 can also include one or more die-cast parts.

LED bulb 100 is filled with thermally conductive liquid 111 for transferring heat generated by LEDs 103 to shell 101. The thermally conductive liquid 111 fills the enclosed volume defined between shell 101 and bulb base 110, allowing the thermally conductive liquid 111 to thermally conduct with both the shell 101 and the bulb base 110. In some embodiments, thermally conductive liquid 111 is in direct contact with LEDs 103.

Thermally conductive liquid 111 may be any thermally conductive liquid, mineral oil, silicone oil, glycols (PAGs), fluorocarbons, or other material capable of flowing. It may be desirable to have the liquid chosen be a non-corrosive dielectric. Selecting such a liquid can reduce the likelihood that the liquid will cause electrical shorts and reduce damage done to the components of LED bulb 100.

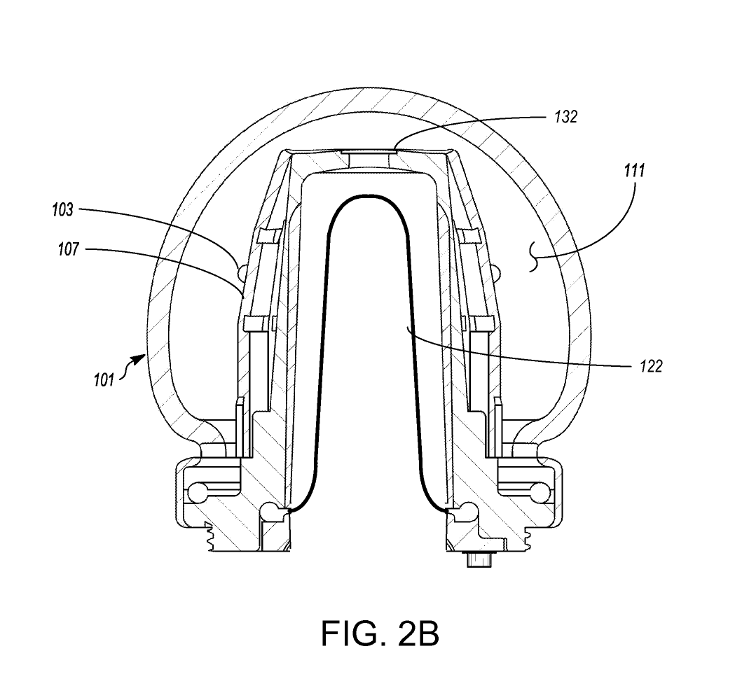

LED bulb 100 includes a mechanism to allow for thermal expansion of thermally conductive liquid 111 contained in the LED bulb 100. In the present exemplary embodiment, the mechanism is a bladder 120. In FIG. 2A, the bladder 120 is disposed in a cavity 130 of the bulb base 110. The cavity 130 is in fluidic connection with the enclosed volume created between the shell 101 and base 110. As shown in FIG. 2A, a channel 132 connects the enclosed volume and the cavity 130, allowing the thermally conductive liquid 111 to enter the cavity 130. The outside surface of the bladder 120 is in contact with the thermally conductive liquid 111. The volume of the cavity that is not occupied by the bladder 120 is typically filled with the thermally conductive liquid 111. The bladder 120 is capable of compression and/or expansion to compensate for expansion of the thermally conductive liquid 111.

FIG. 2B depicts an alternative configuration using a diaphragm 122 to compensate for thermal expansion of the thermally conductive liquid. In this embodiment, one surface of the diaphragm 122 is in fluidic connection with the thermally conductive liquid. The opposite surface is typically exposed to ambient pressure conditions (e.g., vented to the ambient air outside the bulb). The diaphragm 122 is capable of deformation and/or movement to compensate for expansion of the thermally conductive liquid 111.

Using a liquid-filled bulb offers several distinct advantages over traditional air-filled bulbs. As discussed above, a bulb filled with a thermally-conductive liquid provides improved heat dissipation from the LEDs, as compared to an air filled bulb. In addition, because the thermally conductive liquid is disposed between the LED and the shell, the thermally conductive liquid can act as a lens for directing the light emitted by the LEDs.

As discussed above, it may be desirable to produce an LED bulb having a uniform light-distribution profile that satisfies Energy Star requirements. Specifically, it may be desirable to produce an LED bulb having a light-distribution profile that does not vary more that 20 percent over 0 degrees to 135 degrees, as measured from an axis extending from the center of the shell to the apex of the shell, as provided by Energy Star Program Requirements for Integral LED Lamps, Section 7A. It may also be desirable to produce an LED bulb that exceeds Energy Star uniformity requirements. For example, it may be desirable to produce an LED bulb having a light-distribution profile that does not vary more than 18, 15, 14, or 11 percent over 0 degrees to 135 degrees. However, as previously mentioned, an LED bulb may not inherently produce a uniform light-distribution profile that satisfies these criteria.

The techniques discussed below leverage the optical properties of a liquid-filled LED bulb to produce an LED bulb having a uniform light distribution. Specifically, the angle and vertical placement the LEDs within the shell, the shape of the shell, and a diffuser band on the shell can be used, alone or in combination, to produce an LED bulb having a predicted light-distribution profile that meets Energy Star specifications.

In the examples provided below, for purposes of modeling, the LEDs are assumed to have a Lambertian emission profile with a peak light intensity at an angle approximately perpendicular to the face of the LED. Typically, less light is emitted from the LED as the emission angle from the face of the LED is increased. The light-distribution profile of a typical LED (without the aid of additional optical elements) may not meet uniformity criteria provided by the Energy Star specification.

A liquid-filled shell can be used to increase the uniformity of the light emitted from an LED. In the examples provided below, a shell having an index of refraction of approximately 1.5 is filled with a thermally conductive liquid having an index of refraction of approximately 1.4. The shell and the thermally-conductive liquid together act as a lens for diverting light toward portions of the LED bulb where the LED emissions may be weaker.

The indices of refraction of the shell and thermally conductive liquid, the angle and position of the LEDs with respect to the shell, the profile shape of the shell, and the location of a diffuser band all affect how the light emitted from the LED is diverted by the LED bulb. As discussed in more detail below, one or more of these parameters can be optimized to produce an LED bulb having a predicted light-distribution profile that satisfies uniformity criteria.

### 2. Calculating Angle and Height of an LED

As discussed above, it may be desirable to produce an LED bulb having a light-distribution profile that satisfies Energy Star uniformity requirements. Specifically, it may be desirable to produce an LED bulb having a light-distribution profile that does not vary more that 20 percent with respect to a mean intensity over 0 degrees to 135 degrees, as measured from an axis extending from the center of the shell to the apex of the shell.

Using a liquid-filled bulb as described above with respect to FIG. 1, the LEDs, thermally-conductive liquid, and shell form an optical system that can be configured to produce a desired light distribution. In the examples described below, the angle and the vertical placement of the LEDs with respect to the shell are calculated to produce an LED bulb having a light-distribution profile that satisfies specified uniformity criteria.

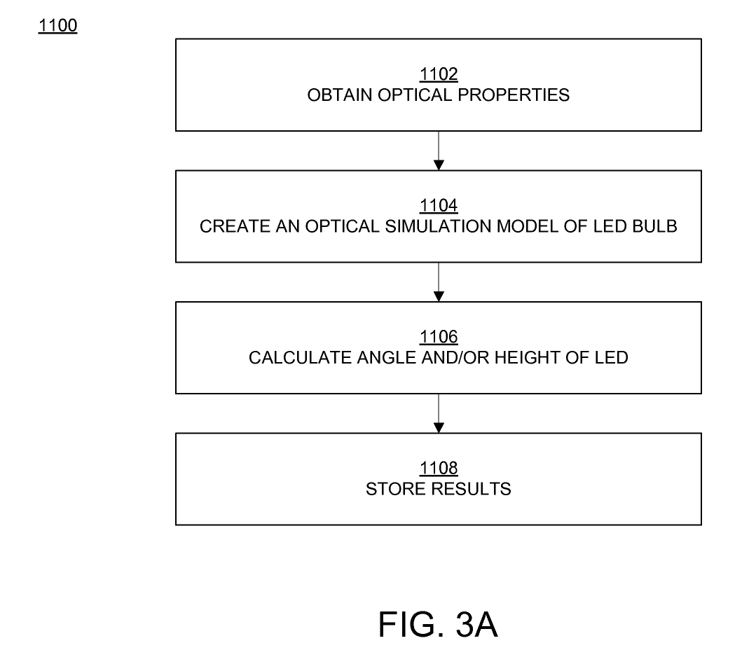

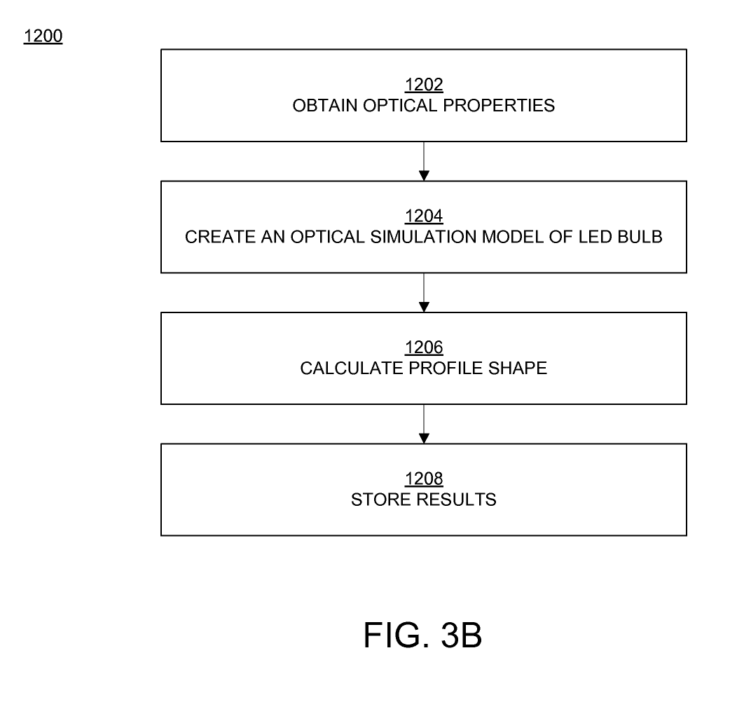

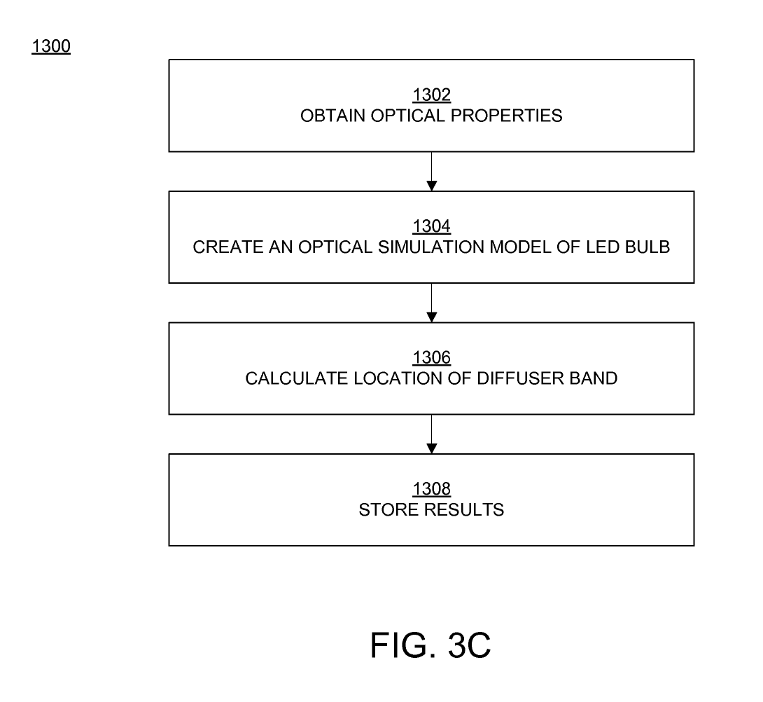

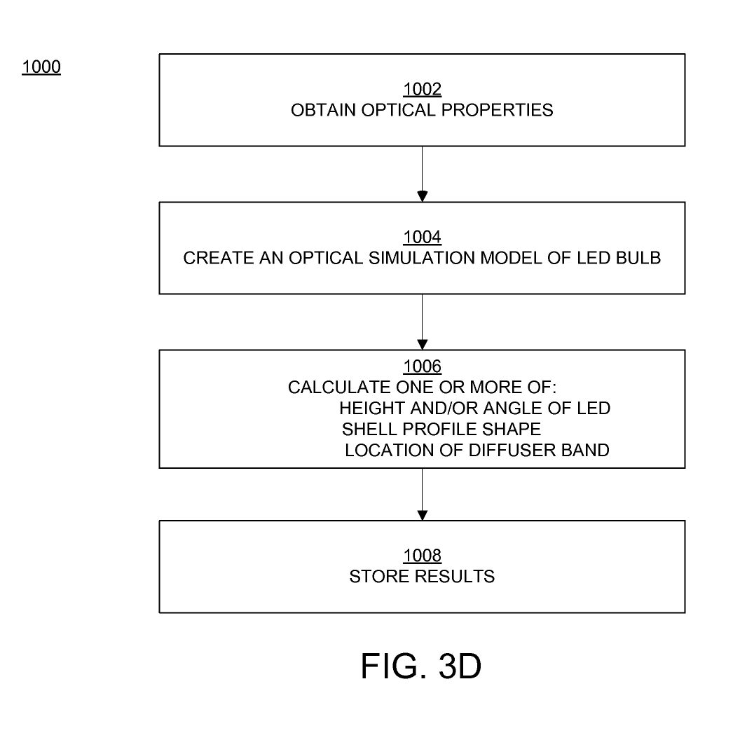

FIG. 3A depicts an exemplary process 1100 for providing a light emitting diode (LED) bulb having a light-distribution profile that satisfies a uniformity criterion by calculating an angle and height for the LEDs. Process 1100 can be used to calculate an optical configuration for an LED bulb having a predicted light-distribution profile that satisfies Energy Star uniformity requirements.

In operation 1102, optical properties of the shell and thermally conductive liquid are obtained. The optical properties may include, for example, the index of refraction and optical transmissivity of the shell and thermally conductive liquid. In addition, the index of reflection of optical coatings on the shell or other optical components may also be obtained.

In operation 1104, an optical simulation model is created. The optical simulation model simulates the optical and geometric configuration of the LED bulb relevant to an optical analysis of the LED bulb. In this example, the optical simulation model simulates the geometry and position of LED bulb components that are relevant to an optical analysis of the far-field intensity of light emitted by one or more LEDs. The optical simulation model is typically created using a computer system having a processor and computer-readable memory configured to execute optical simulation software. The optical simulation model may be created using commercially available optical modeling tools, including, for example, APEX optical modeling software produced by Breault Research Organization for use with SolidWorks solid component models, or LightTools optical design and analysis software produced by Synopsys.

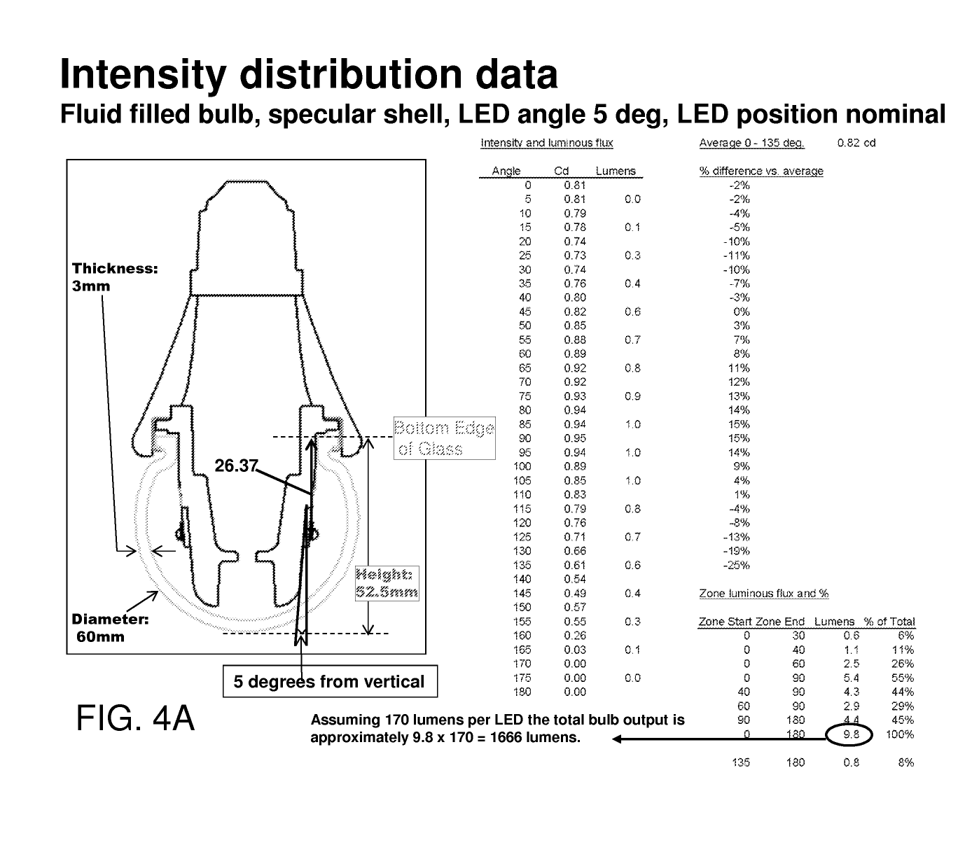

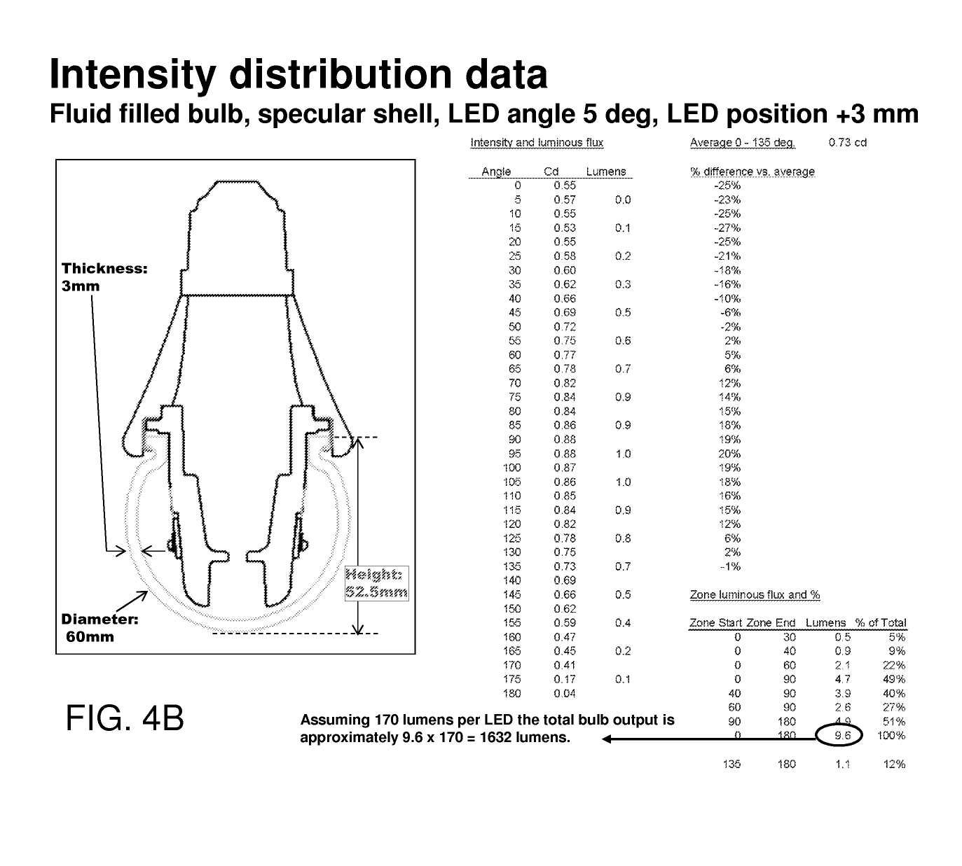

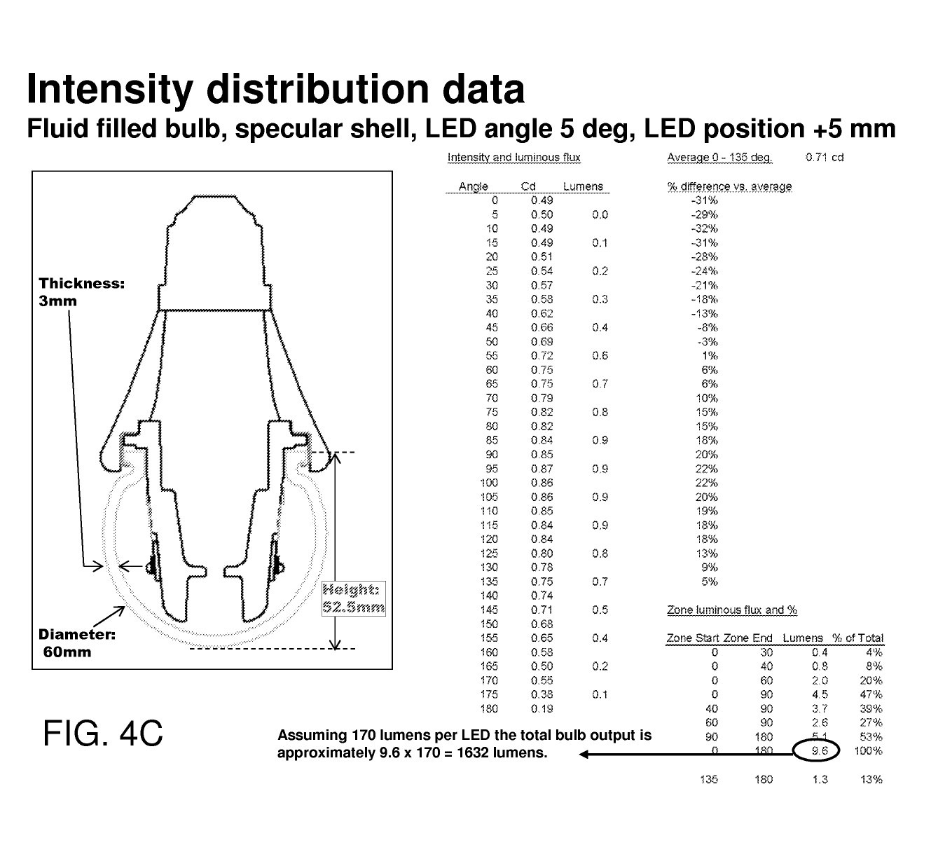

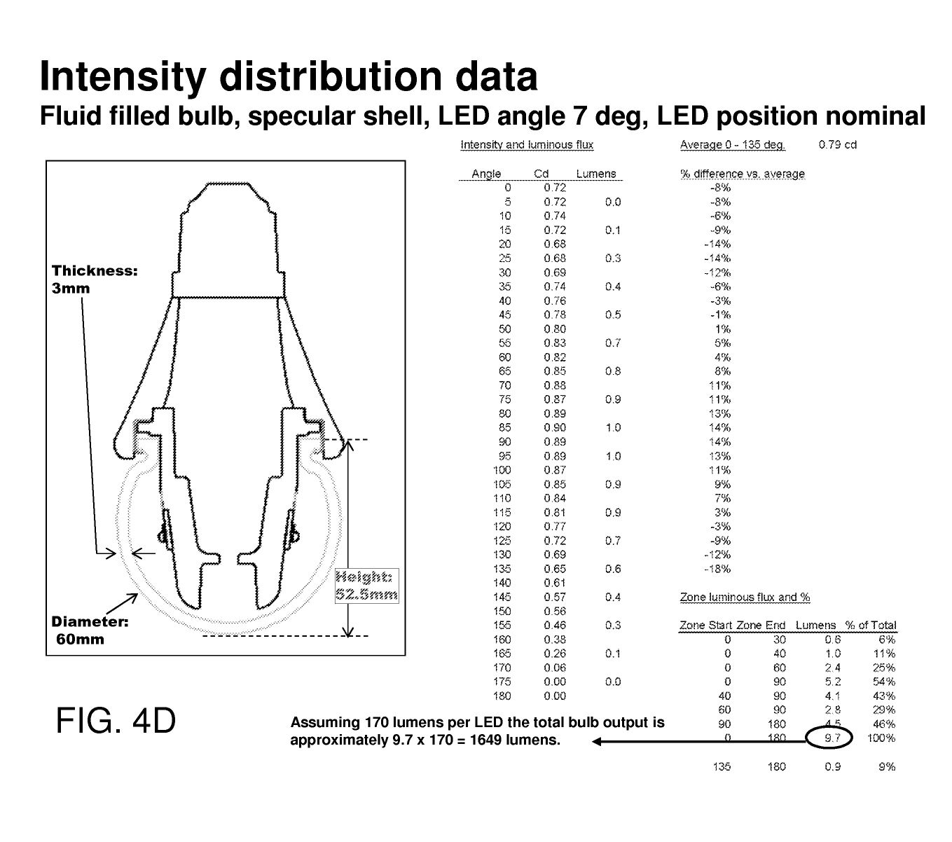

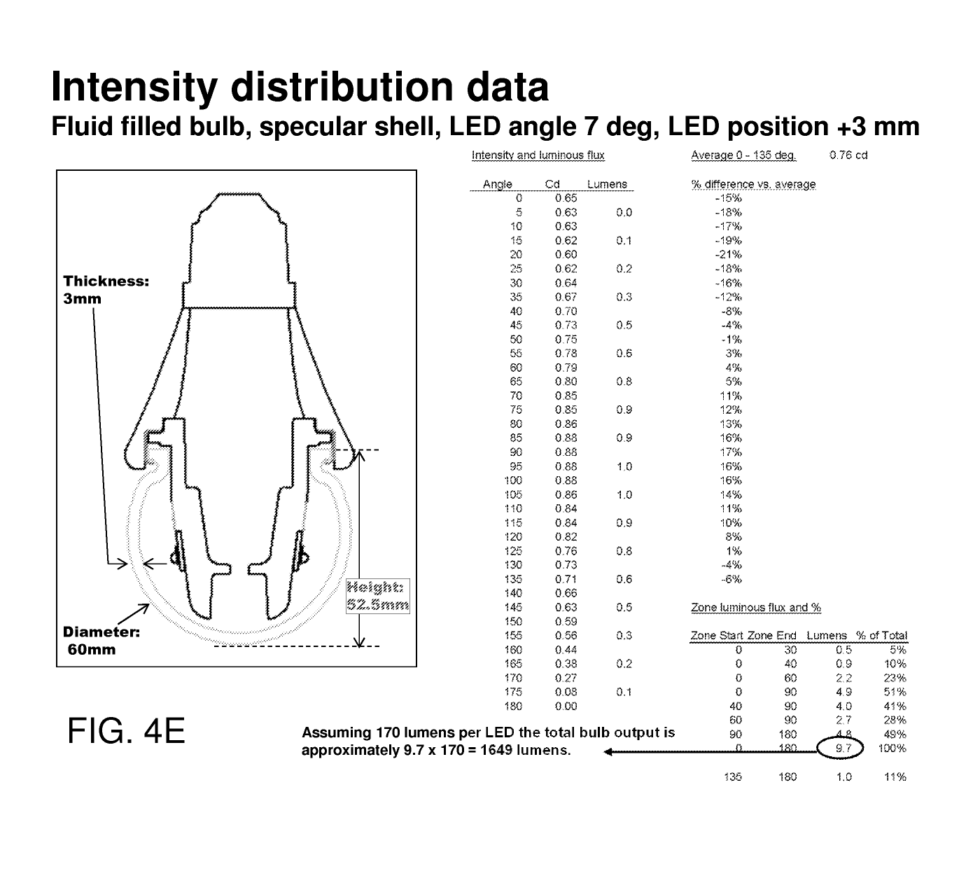

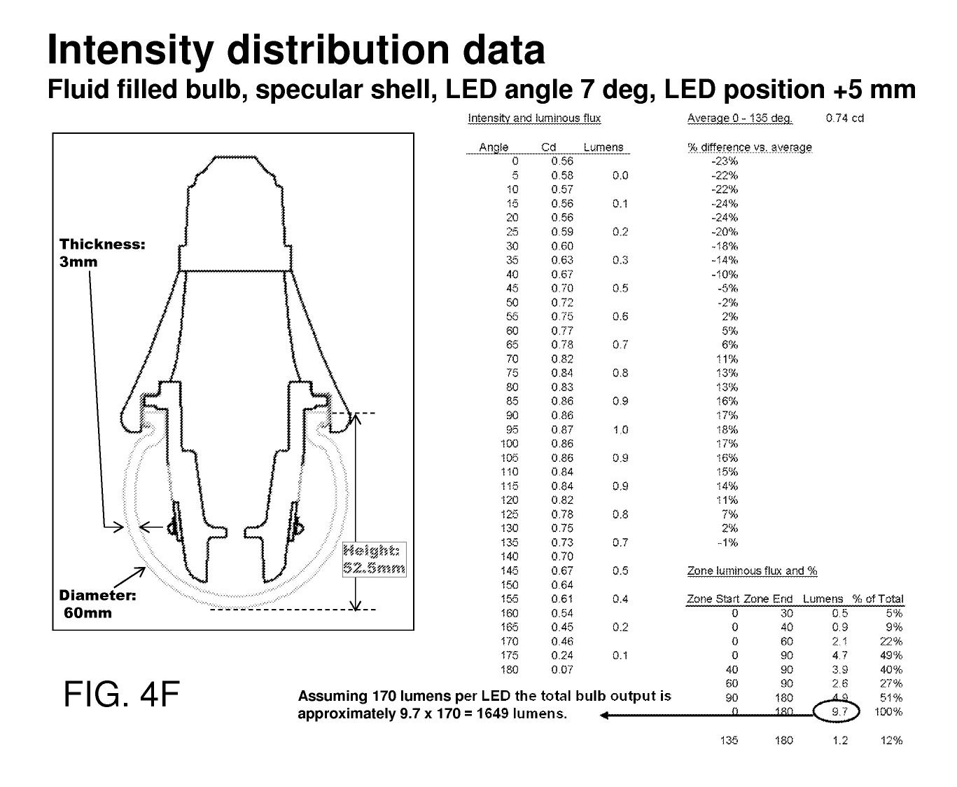

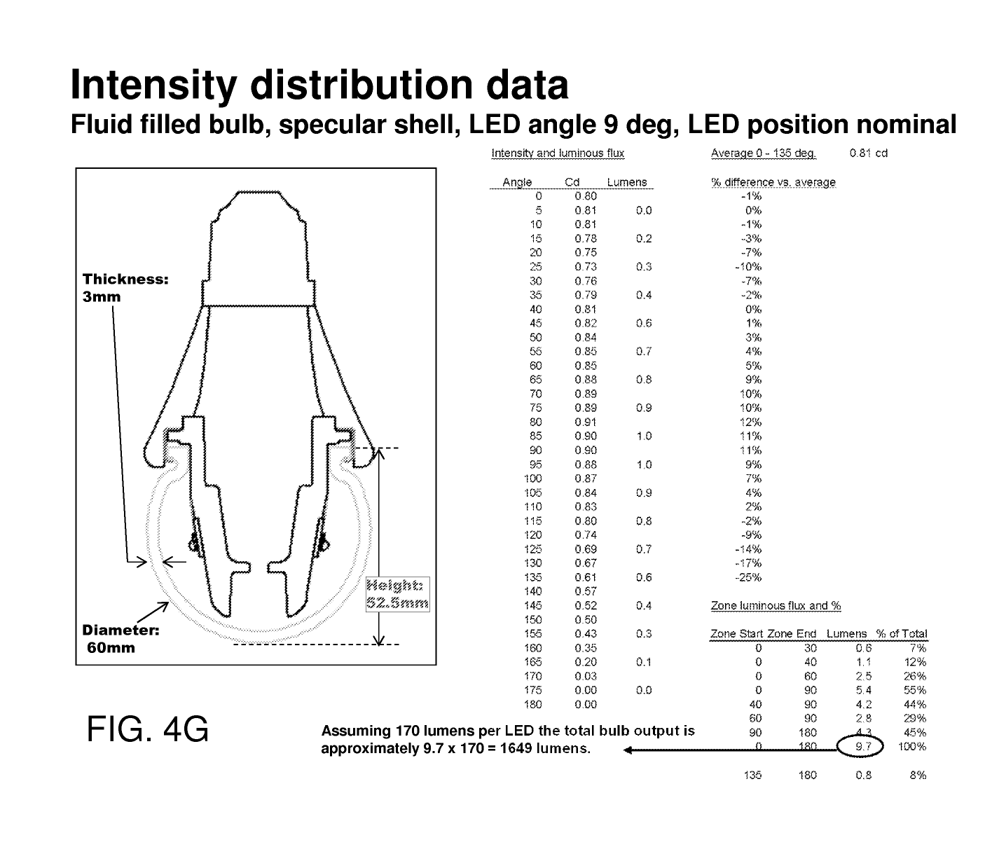

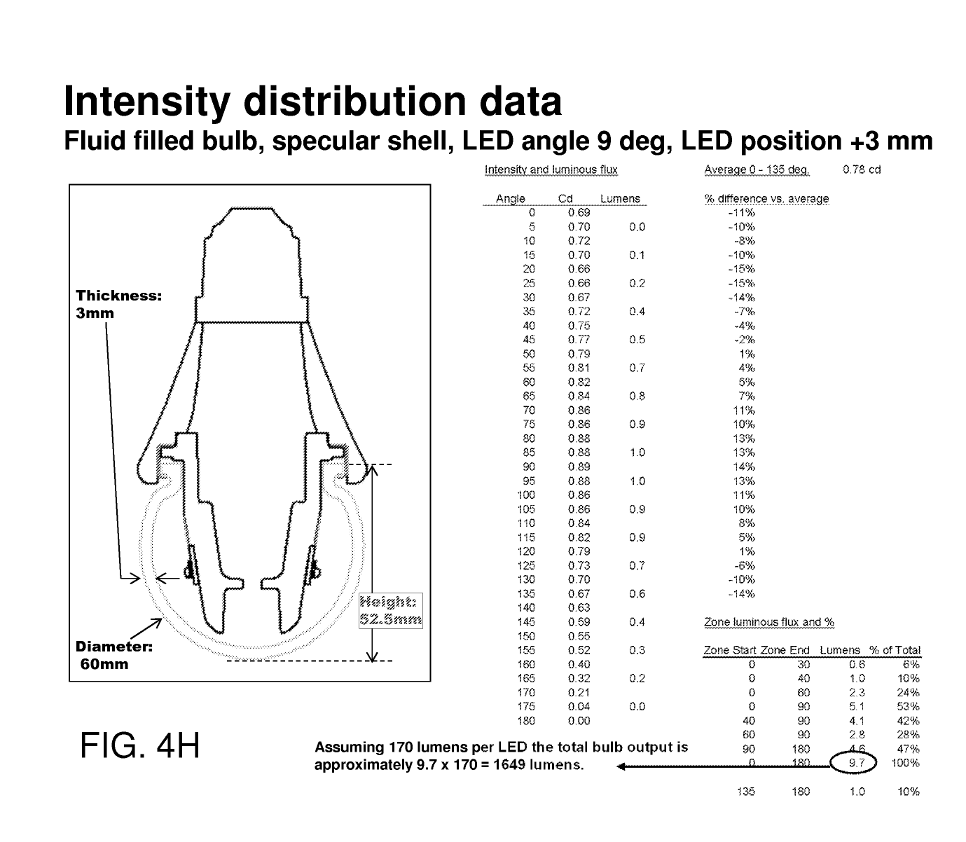

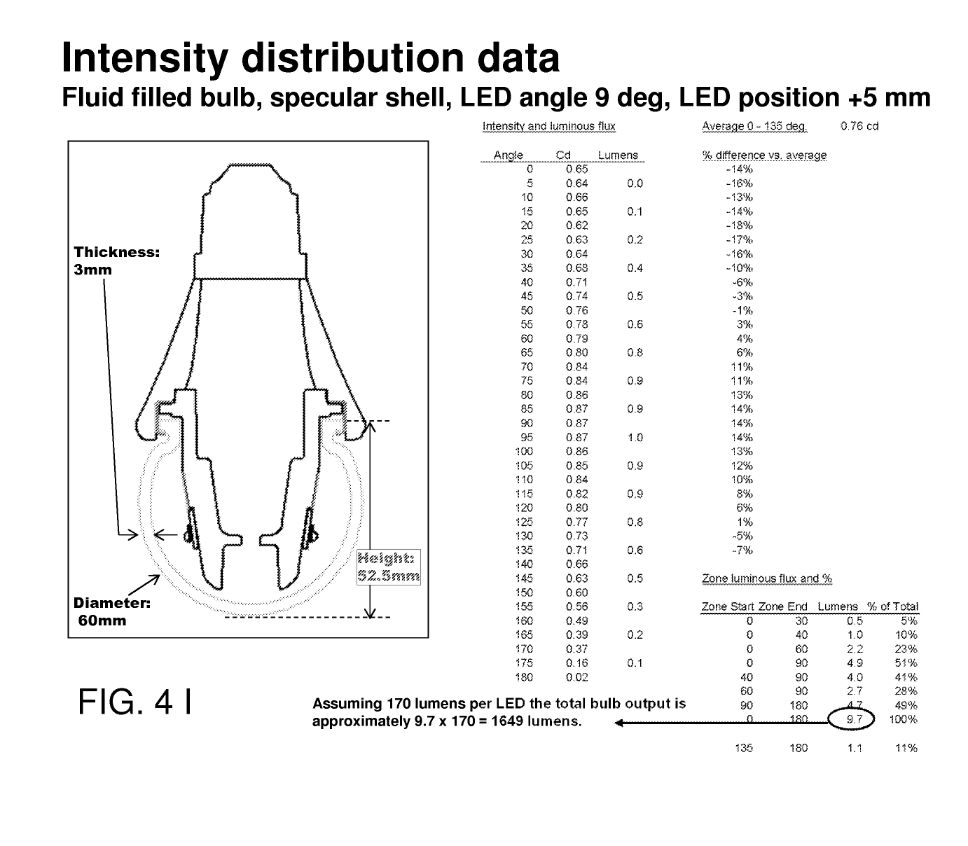

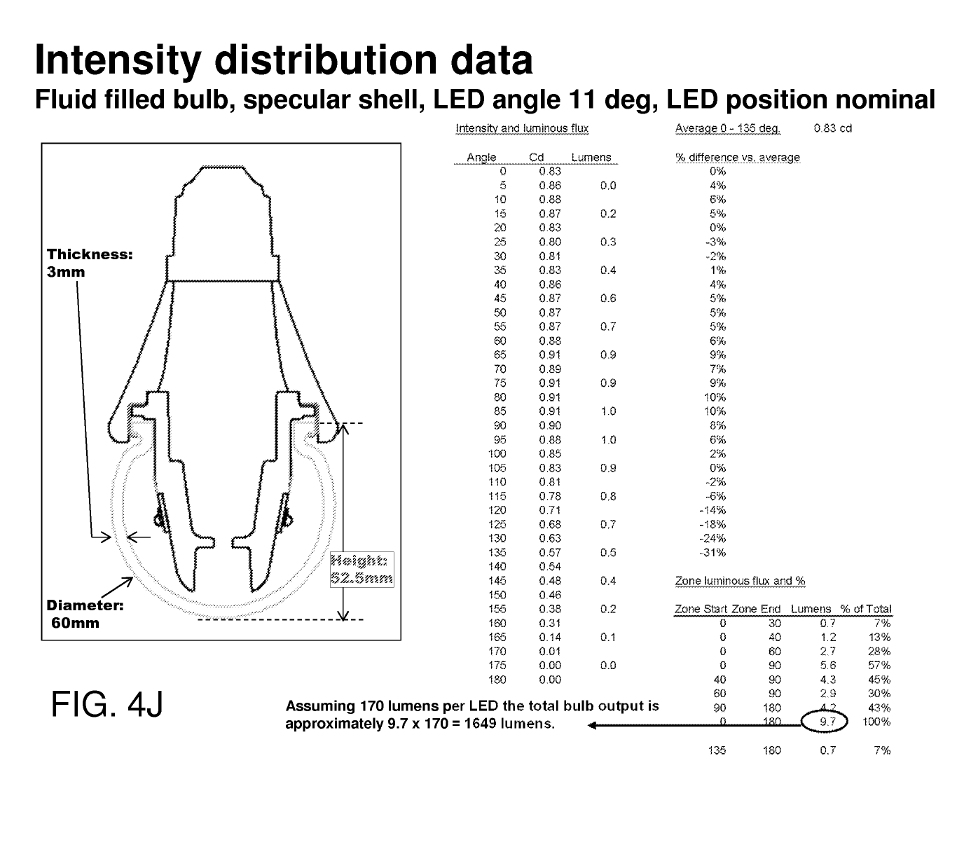

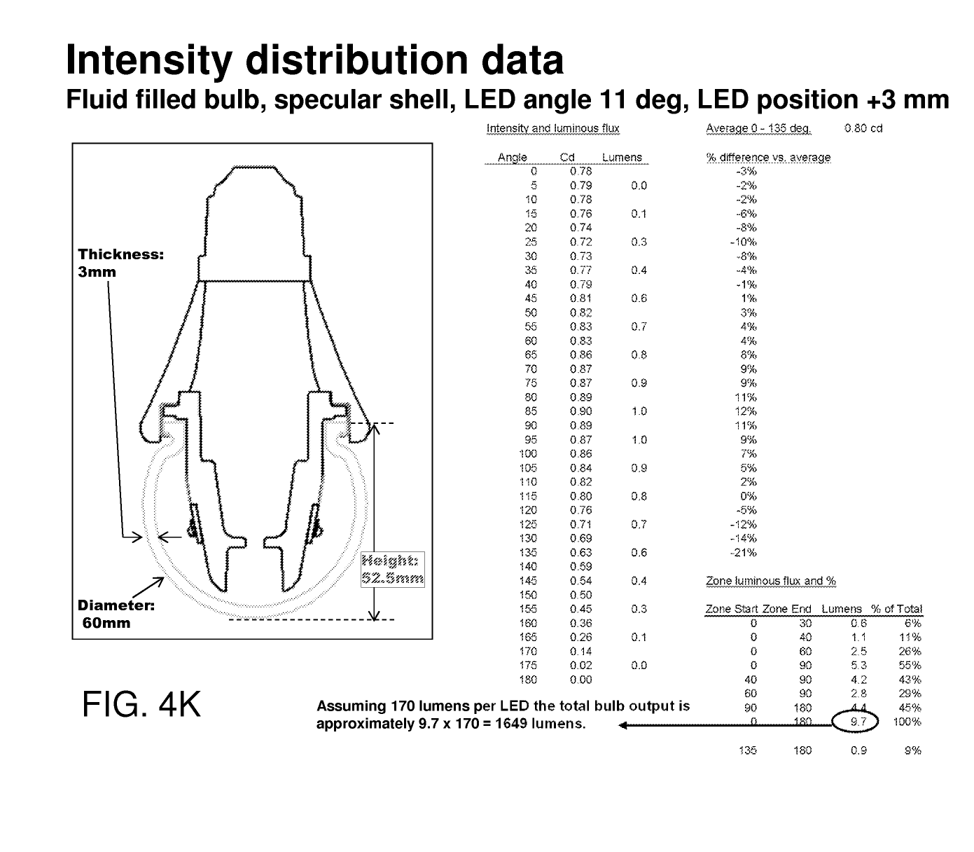

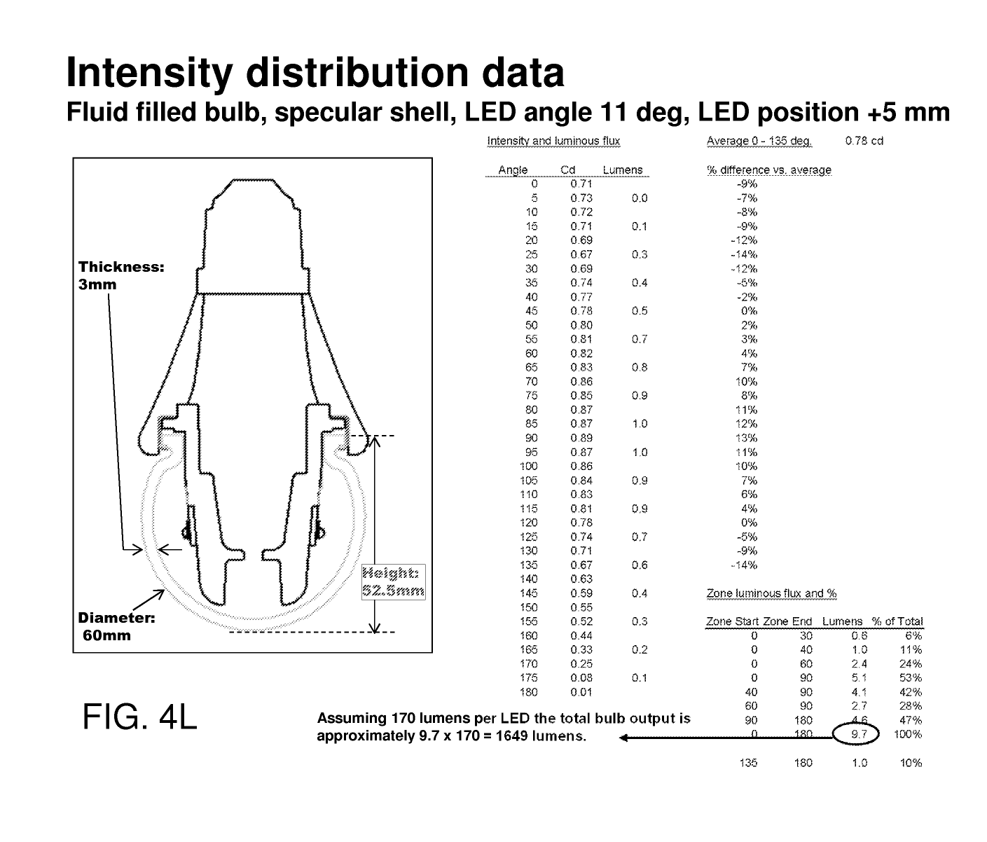

In one example, the optical simulation model includes one or more simulated LED (of a plurality of bulb LEDs) disposed within a simulated shell and a simulated thermally conductive liquid disposed between the one or more simulated LEDs and the interior of the simulated shell. The optical simulation model may also include a simulated base, simulated support structures, and other simulated components of the LED bulb. FIG. 4A depicts a cross-sectional view of an optical simulation model, including two simulated LEDs, simulated thermally conductive liquid, a simulated shell, simulated support structures, and a simulated base. The geometry of the simulated components may be created using a commercially available modeling tool, such as a SolidWorks solid modeler. The geometry of the components may be imported into the optical simulation model using, for example, the Apex optical modeling tool.

In operation 1106, an angle and height of the LEDs are calculated. In this example, the angle and height of the LEDs are calculated based on the optical simulation model created in operation 1104 and the optical properties obtained in operation 1102. Specifically, in this example, at least one optical analysis is conducted using the optical simulation model to obtain a far-field intensity distribution over a specified area of the simulate LED bulb. The optical analysis may include a ray-trace optical analysis that calculates the angle and intensity of a plurality of simulated light rays emitted by the one or more simulate LEDs. Light scattering, reflection, and absorption may also be computed as part of the optical analysis.

With respect to operation 1106, multiple analyses may be conducted using various LED angles and LED height positions to obtain multiple far-field intensity distributions. FIGS. 4A-L, discussed in more detail below, depict exemplary results of multiple optical analyses for various LED angles and LED heights. In the results depicted in 4A-L, other parameters, such as shell profile and thickness, are constant. To perform multiple analyses, the various parameters of the LED bulb, such as LED position, may be modified using the optical modeling tool (e.g., APEX) or re-imported into the optical modeling tool from another modeling software tool (e.g., SolidWorks solid modeler). The results of the multiple optical analyses may be compared to select an angle and height of the LEDs that results in a light-distribution profile that satisfies a uniformity criterion. As previously mentioned, the uniformity criterion may be based on the Energy Star specifications for light-distribution profile uniformity.

In the example provided below with respect to FIGS. 4A-L, multiple analyses can be performed for 2 degree increments of the LED angles and 2 mm increments of the LED height. The mean light intensity can be simulated over a range of profile angle and a deviation from the mean can be computed. The angle and height of the LEDs can be computed by optimizing the deviation from mean for both the LED angle and LED height. In one example, the deviation from mean is optimized by varying the LED angle. The deviation from mean can then be optimized by varying the LED height. The optimization for the LED angle can be performed again for the optimal LED height. Other techniques for optimizing the light-distribution profile for the angle and height of the LED can also be performed.

In another implementation, multiple candidate configurations can be selected as having a deviation from the mean light intensity, over 0 degrees to 135 degrees, not to exceed a threshold (e.g., 20 percent). Any one of the selected configurations can be used to produce an LED bulb having a light-distribution profile that satisfies uniformity criteria. In some cases, the candidate with the most uniform light-distribution profile is selected as the optimum configuration.

In operation 1108, the results are stored in computer memory. In some cases, the height and angle calculated in operation 1106 are stored in computer-readable memory, including, RAM, hard drive storage media, optical storage media, or the like. In some cases, the results of at least one of the optical analysis performed in operation 1106 are stored in computer-readable memory. The stored results can be used to construct an LED bulb having one or more LEDs disposed within a shell at the angle and height calculated in operation 1106. In some embodiments, the stored results can be used to produce an LED bulb having a predicted light-distribution profile that does not deviate more than 20 percent from mean over 0 degrees to 135 degrees as measured from an axis extending from the center of the shell to the apex of the shell.

As previously mentioned, FIGS. 4A-L depict the results of an optical analysis of a simulated LED bulb for various angles and vertical locations (i.e., heights) of the LEDs. The simulations of FIGS. 4A-L are performed for a simulated LED bulb having a simulated LED with a Lambertian emission profile and a normalized light output of 1 lumen. The simulated LED bulb depicted in FIGS. 4A-L has a simulated shell with a uniform diameter of 60 mm and a simulated base with a width of approximately 60 mm at the location where the base interfaces with the shell.

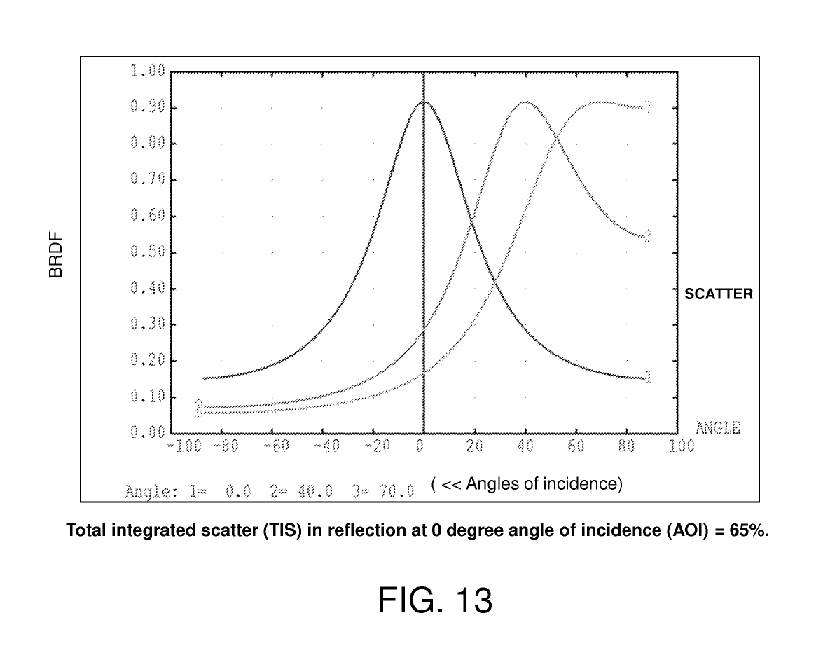

The analysis accounts for the optical properties of various components of the LED bulb. For the analysis depicted in FIGS. 4A-L, the index of refraction of the thermally-conductive liquid is assumed to be 1.41 for the simulation, and the index of refraction of the shell is assumed to be 1.52 for the simulation. For purposes of the all the simulations provided herein, the simulations were normalized to 1 lumen per simulated LED. The optical properties of the base and support structures, including surface finish to simulate optical scattering were also taken into account. FIG. 13 depicts an exemplary bidirectional reflectance distribution function (BRDF) applied to the simulated support structures and the simulated base.

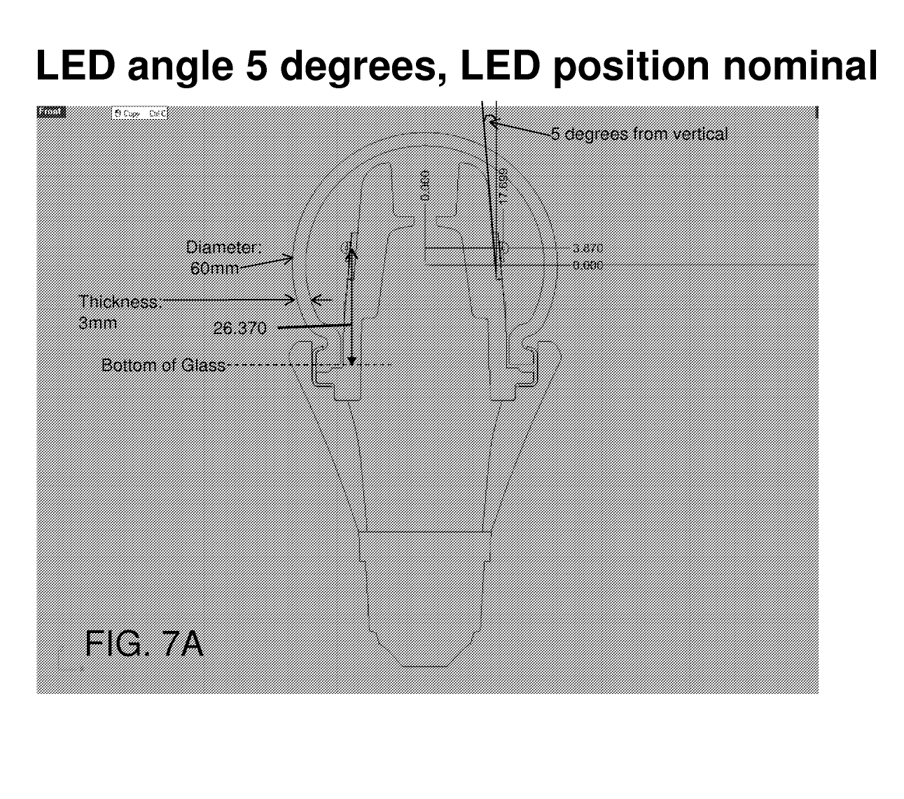

The optical analysis depicted in FIGS. 4A-L simulates the far-field light distribution for various configurations of a simulated LED bulb. Specifically, the far-field light intensity, measured in candela, is simulated and reported in 5 degree increments, as measured from an axis extending from the center of the shell to the apex of the shell. The far-field luminous flux, measured in lumens, is also simulated and reported in 10 degree increments. The percent difference in light intensity with respect to an average light intensity is also calculated and reported in 5 degree increments. Selected dimensions of the various configurations of the LED bulb are shown in FIGS. 7A-L and correspond to the optical analysis depicted in FIGS. 4A-L

FIG. 4A depicts an optical analysis of an LED bulb having a nominal LED height (26.37 mm from the bottom edge of the shell or 3.87 mm from the center of the shell) and an LED mount angle of 5 degrees. As shown in FIG. 4A, a nominal height results in a maximum percent deviation from average of +15% and −25%, over 0 degrees to 135 degrees. FIG. 4B depicts an optical analysis of an LED bulb having a height approximately +3 mm from nominal (29.36 mm from the bottom edge of the shell or 6.86 mm from the center of the shell) and an LED mount angle of 5 degrees resulting in a maximum deviation from average of +20% and −25%. FIG. 4C depicts an optical analysis of an LED bulb having a height approximately +5 mm from nominal (31.35 mm from the bottom edge of the shell or 8.51 mm from the center of the shell) and an LED mount angle of 5 degrees resulting in a maximum deviation from average of +22% and −31%.

FIGS. 4D-F depict configurations having an LED mount angle of 7 degrees. FIG. 4D depicts an LED bulb having a nominal LED height (26.37 mm from the bottom edge of the shell or 3.87 mm from the center of the shell) resulting in a maximum deviation from average of +14% and −18%, over 0 degrees to 135 degrees. FIG. 4E depicts an LED bulb having a height approximately +3 mm from nominal (29.37 mm from the bottom edge of the shell or 6.85 mm from the center of the shell) resulting in a maximum deviation from average of +17% and −21%. FIG. 4F depicts an LED bulb having a height approximately +5 mm from nominal (31.38 mm from the bottom edge of the shell or 8.83 mm from the center of the shell) resulting in a maximum deviation from average of +18% and −24%.

FIGS. 4G-I depict configurations having an LED mount angle of 9 degrees. FIG. 4G depicts an LED bulb having a nominal LED height (26.46 mm from the bottom edge of the shell or 3.96 mm from the center of the shell) resulting in a maximum deviation from average of +12% and −25%, over 0 degrees to 135 degrees. FIG. 4H depicts an LED bulb having a height approximately +3 mm from nominal (29.33 mm from the bottom edge of the shell or 6.83 mm from the center of the shell) resulting in a maximum deviation from average of +14% and −15%. FIG. 4I depicts an LED bulb having a height approximately +5 mm from nominal (31.31 mm from the bottom edge of the shell or 8.81 mm from the center of the shell) resulting in a maximum deviation from average of +14% and −18%.

FIGS. 4J-L depict configurations having an LED mount angle of 11 degrees. FIG. 4J depicts an LED bulb having a nominal LED height (26.37 mm from the bottom edge of the shell or 3.87 mm from the center of the shell) resulting in a maximum deviation from average of +10% and −31%, over 0 degrees to 135 degrees. FIG. 4K depicts an LED bulb having a height approximately +3 mm from nominal (29.32 mm from the bottom edge of the shell or 6.82 mm from the center of the shell) resulting in a maximum deviation from average of +12% and −21%. FIG. 4L depicts an LED bulb having a height approximately +5 mm from nominal (31.28 mm from the bottom edge of the shell or 8.78 mm from the center of the shell) resulting in a maximum deviation from average of +13% and −14%.

As discussed above with respect to process 1100, the analysis performed in FIGS. 4A-L can be used to calculate the angle and height of the LEDs resulting in an LED bulb capable of producing a light-distribution profile that satisfies Energy Star uniformity criteria. In this example, 4 of the 12 configurations depicted in FIGS. 4A-L satisfy the Energy Star criteria for light-distribution profile uniformity: FIG. 4D depicting an LED bulb with an LED angle of 7 degrees and nominal LED height; FIG. 4H depicting an LED bulb with an LED angle of 9 degrees and a +3 mm LED height; FIG. 4I depicting an LED bulb with an LED angle of 9 degrees and a +5 mm LED height; and FIG. 4L depicting an LED bulb with an LED angle of 11 degrees and a +5 mm LED height. Thus, based on the analysis performed in FIGS. 4A-L, an LED bulb having for LED angles 7, 9 and 11 degrees with respective LED placements of nominal, +3 mm, and +5 mm can be configured to produce a light-distribution profile that satisfies Energy Star uniformity criteria. More generally, and LED bulb having a plurality of LEDs positioned between 3.5 and 10 millimeters from the center of the shell, and positioned at an angle between 4 and 12 degrees from a central axis of the shell can be configured to produce a light-distribution profile that satisfies Energy Star uniformity criteria.

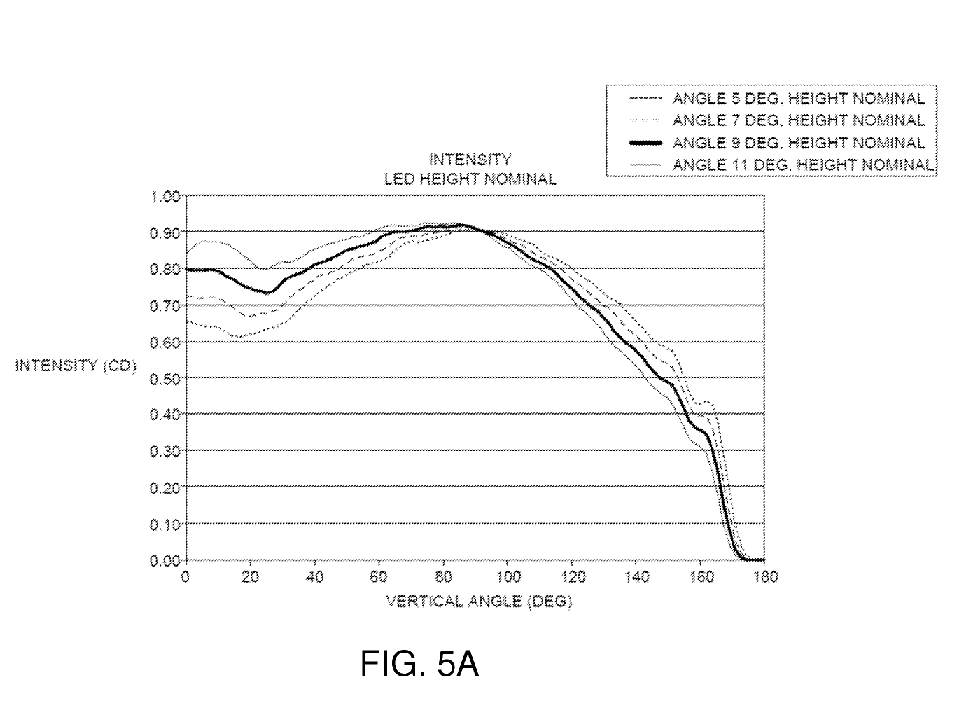

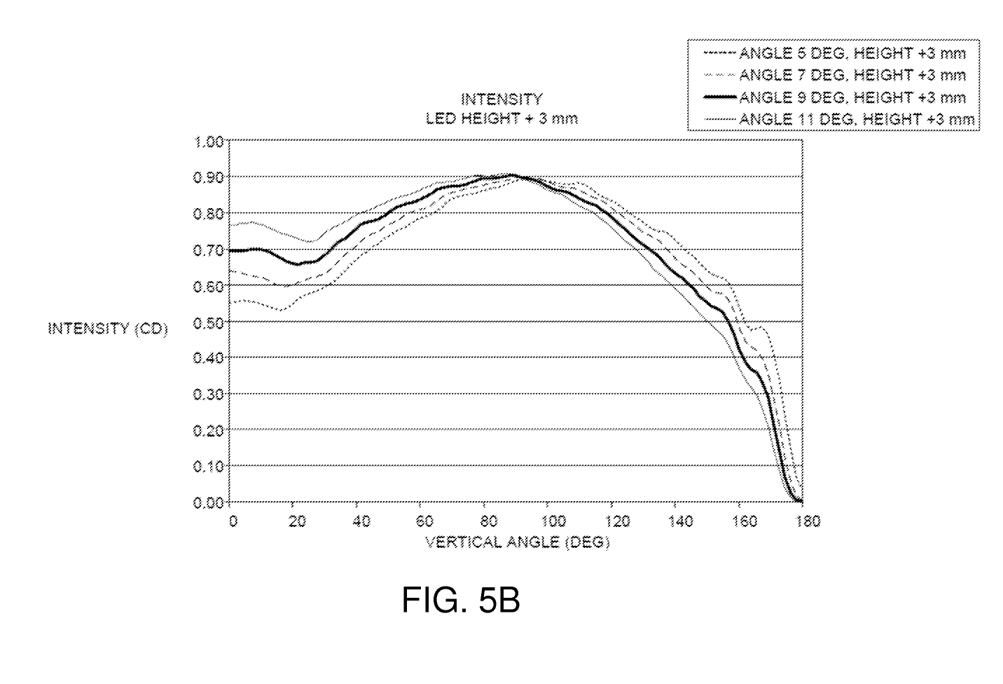

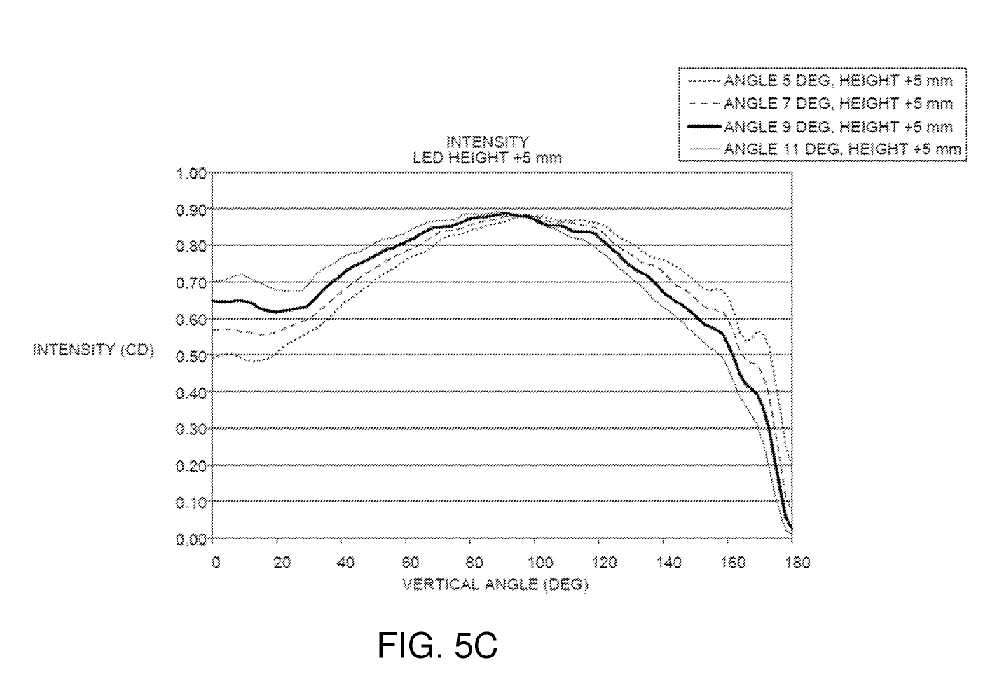

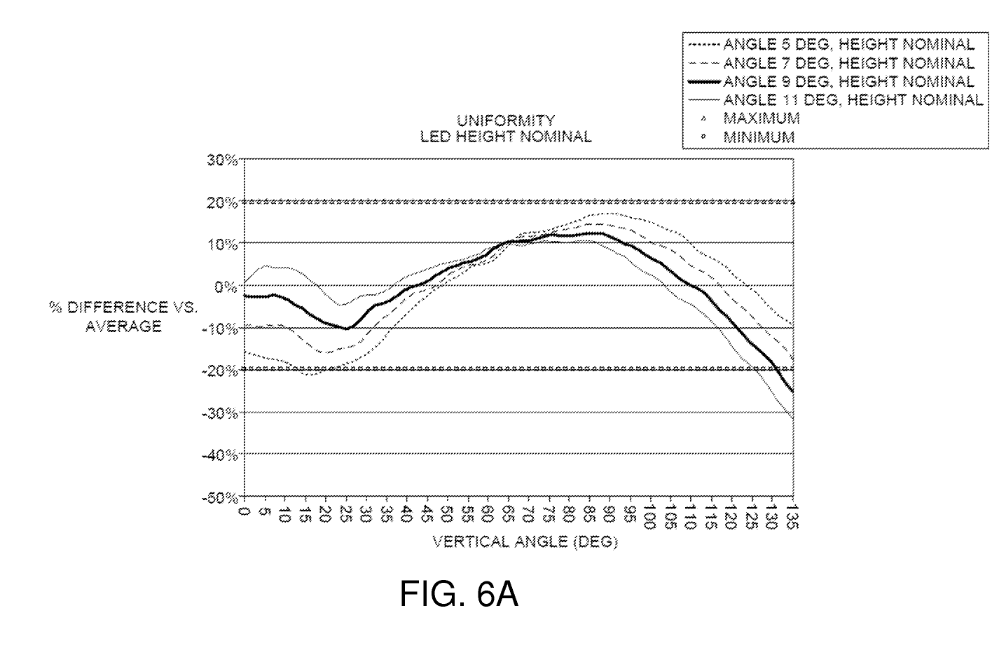

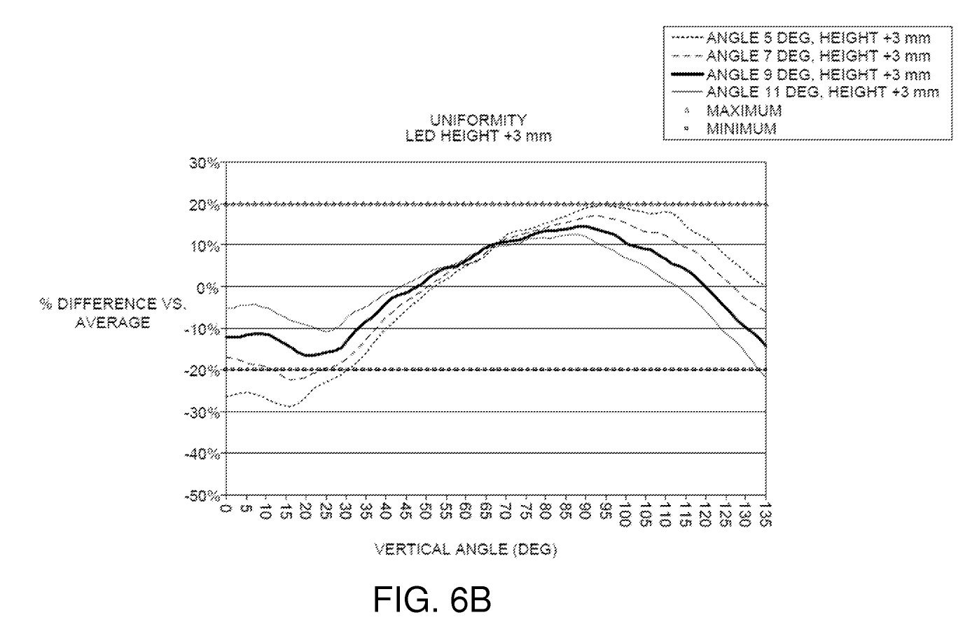

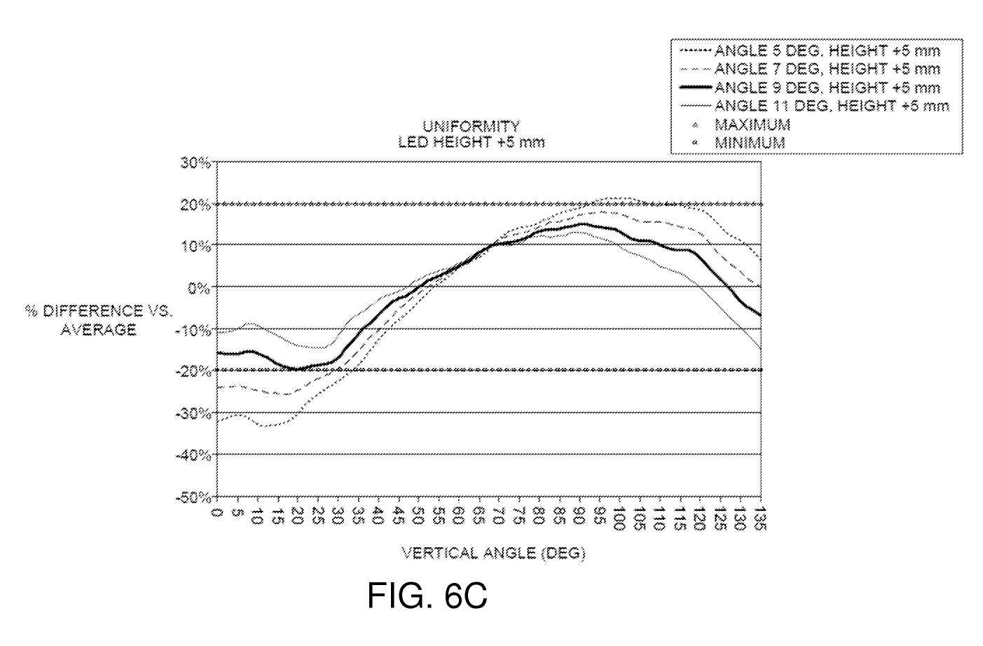

FIGS. 5A-C and 6A-C depict additional visualizations of the results of the analysis performed in FIGS. 4A-L. FIGS. 5A-C depict light intensity versus angle for simulations that correspond to the analysis performed for the LED bulbs shown in FIGS. 4A-L. FIGS. 6A-C depict deviation from average versus angle for simulations that correspond to the analysis performed for the LED bulbs shown in FIGS. 4A-L.

As shown in the visualization of the analysis in FIGS. 5A-C and 6A-C, there is a trade-off between angle of the LED and the height of the LED. For the shell configurations modeled in FIGS. 4A-L, increasing the angle of the LED results in more light at locations near the apex of the shell and less light at locations greater than 100 degrees from the apex. In the examples provided above, an 11 degree LED angle results in a light-distribution profile having the most uniformity between 0 degrees and 135 degrees from the apex.

For the shell configurations modeled in FIGS. 4A-L, increasing the LED-height more light is diverted to locations greater than 100 degrees from apex and less light is diverted to locations between 0 and 25 degrees from apex. In the examples provided above, an LED height approximately +5 from nominal (and at an 11 degree LED angle) results in a light-distribution profile having the most uniformity between 0 degrees and 135 degrees from the apex.

### 2. Calculating the Shape of a Shell for a Liquid-Filled LED

Using a liquid-filled bulb as described above with respect to FIG. 1, the LEDs, thermally-conductive liquid, and shell form an optical system that can be configured to produce a desired light-distribution profile. In the examples described below, a shape of the shell is calculated to produce an LED bulb having a light-distribution profile that satisfies uniformity criteria.

As discussed above, an LED having a Lambertian distribution profile tends to produce the most light perpendicular to the face of the LED and less light as the angle deviates further from perpendicular. One advantage to using a liquid-filled bulb is that the thermally conductive liquid and shell together form a lens that can be shaped to redirect light emitted by the LED from the middle portion of the shell to other portions of the shell. In the example provided below, a shell with a profile shape having multiple radii can be configured to produce and LED bulb having a light-distribution profile that satisfies uniformity criteria.

FIG. 3B depicts an exemplary process 1200 for providing an LED bulb having a light-distribution profile that satisfies uniformity criteria by calculating a shape of the shell. Process 1200 can be used to calculate an optical configuration for an LED bulb having a predicted light-distribution profile that satisfies Energy Star uniformity requirements.

In operation 1202, optical properties of the shell and thermally conductive liquid are obtained. The optical properties may include, for example, the index of refraction and optical transmissivity of the shell and thermally conductive liquid. In addition, the index of reflection of optical coatings on the shell or other optical components may also be obtained.

In operation 1204, an optical simulation model is created. The optical simulation model simulates the optical and geometric configuration of the LED bulb relevant to an optical analysis of the LED bulb. In this example, the optical simulation model simulates the geometry and position of LED bulb components that are relevant to an optical analysis of the far-field intensity of light emitted by one or more LEDs. Examples of the creation of an optical simulation model are provided above with respect to operation 1104 of FIG. 3A.

In operation 1206, a profile shape for the simulated shell is calculated. In this example, the profile shape is calculated based on the optical simulation model created in operation 1204 and the optical properties obtained in operation 1202. Specifically, in this example, at least one optical analysis is conducted using the optical simulation model to obtain a far-field intensity distribution over a specified area of the simulate LED bulb. The optical analysis may include a ray-trace optical analysis that calculates the angle and intensity of a plurality of simulated light rays emitted by the one or more simulate LEDs. Light scattering, reflection, and absorption may also be computed as part of the optical analysis.

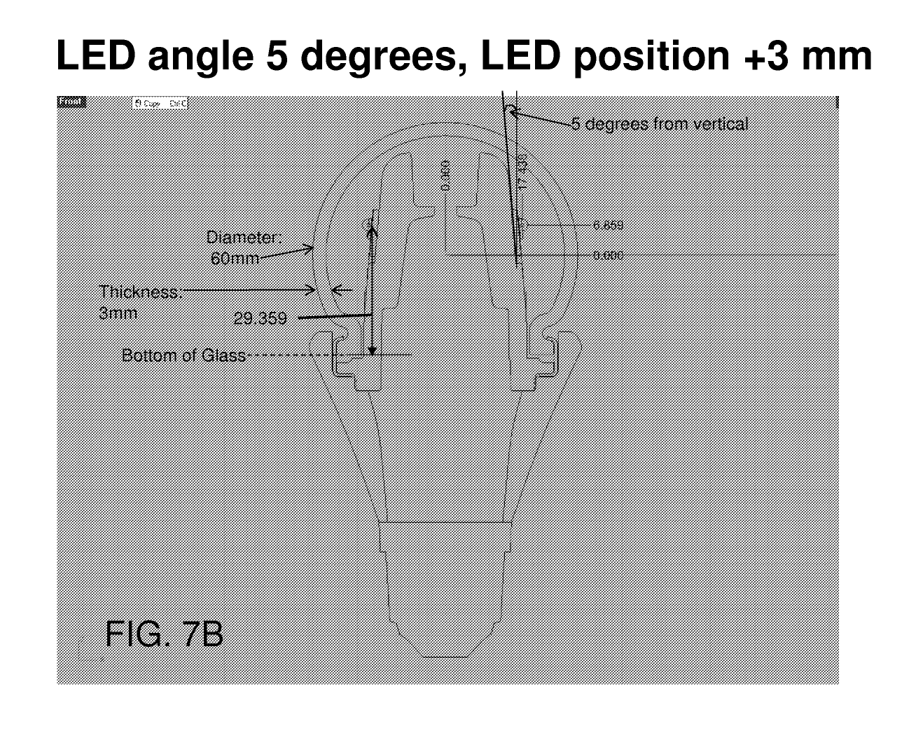

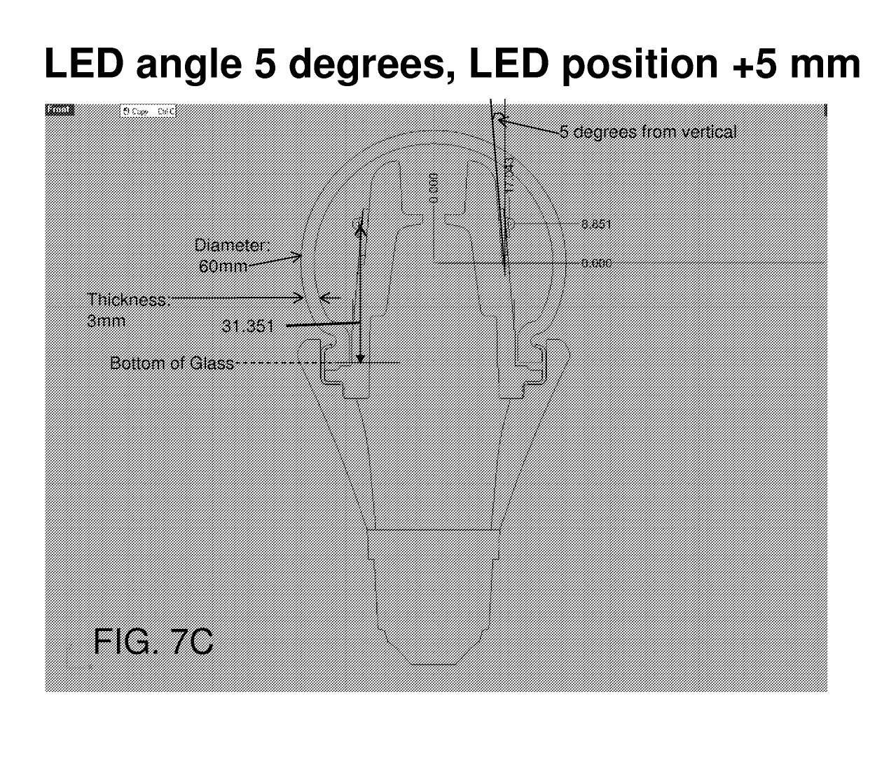

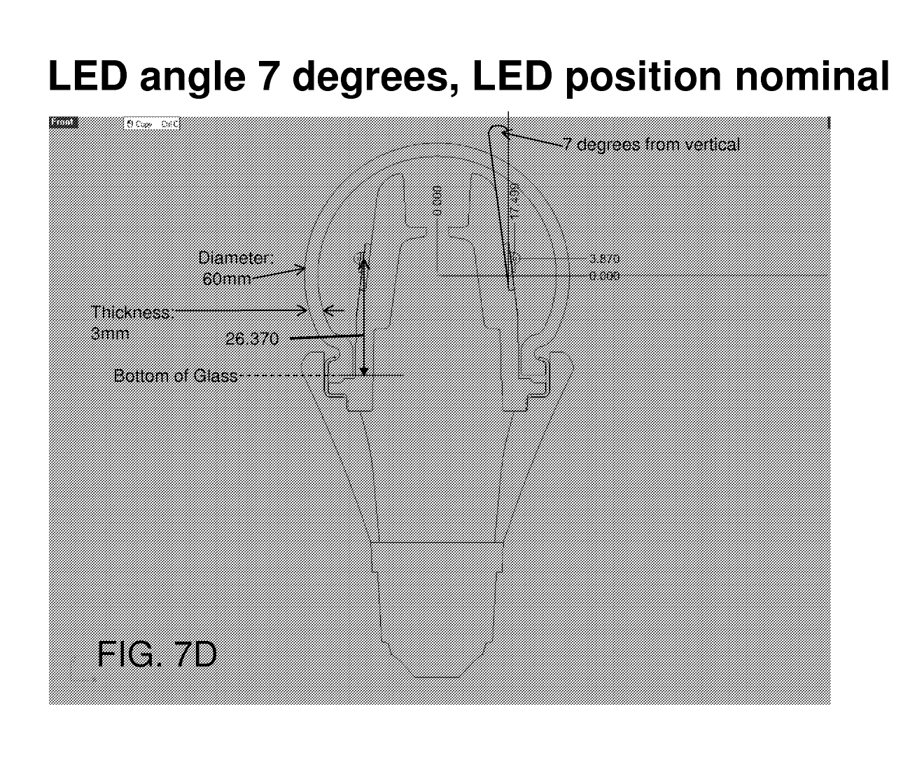

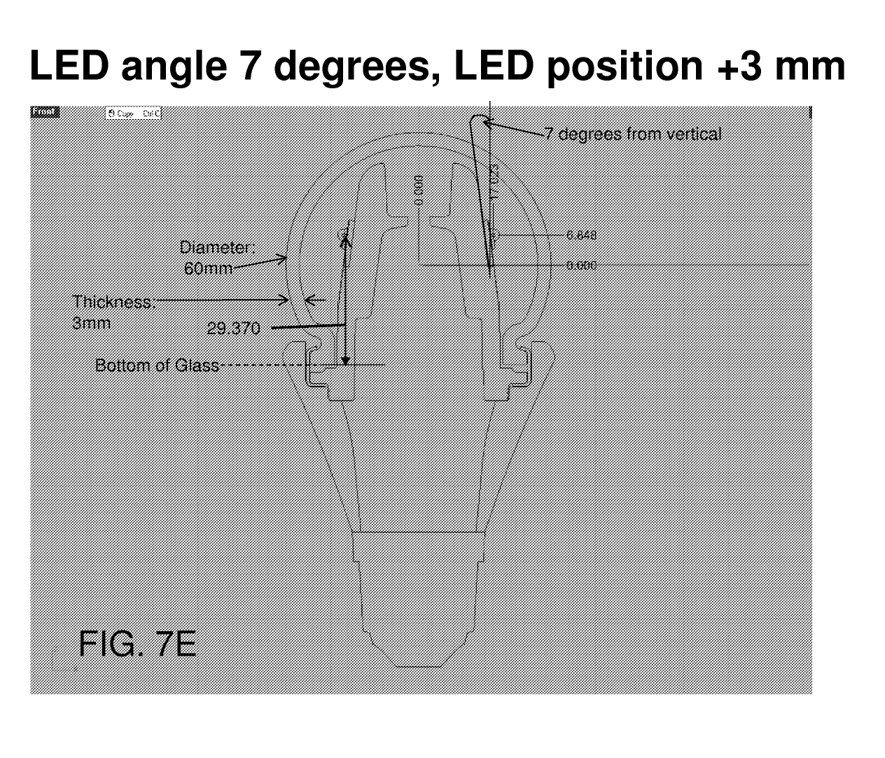

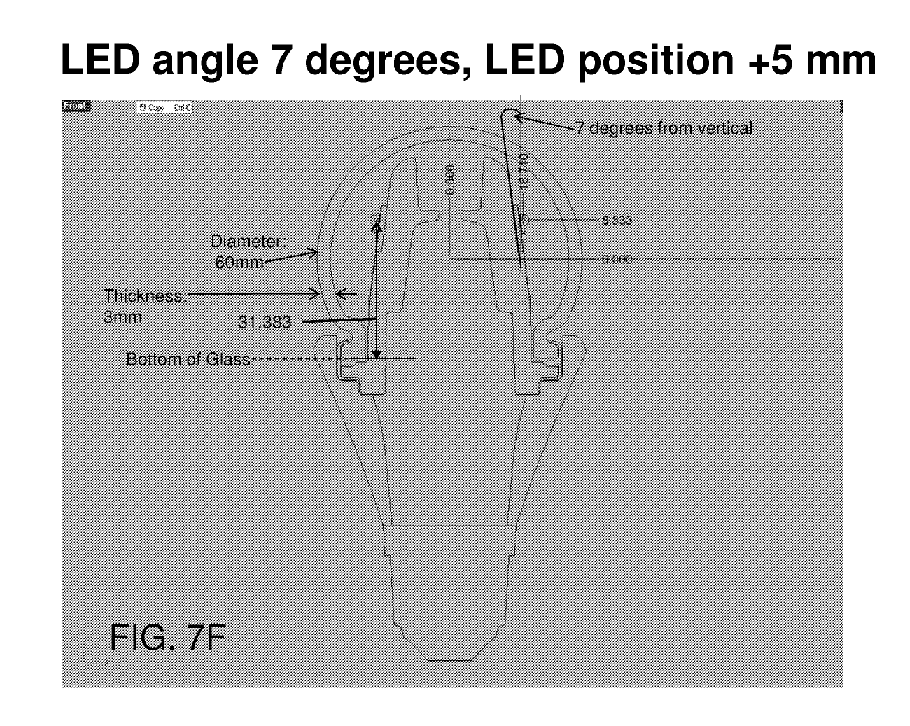

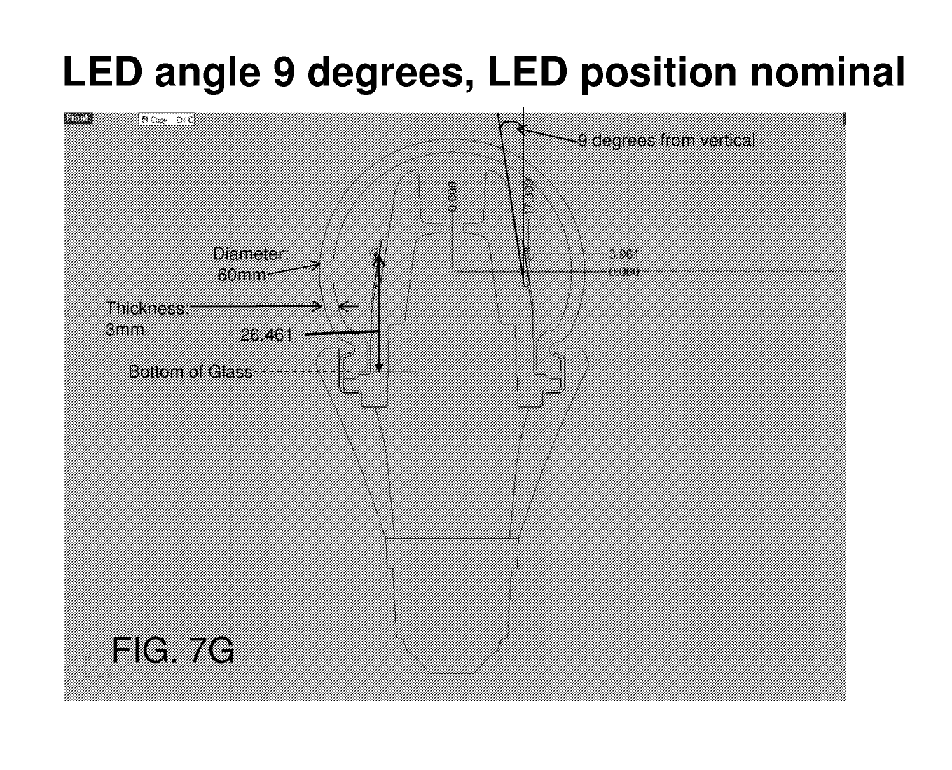

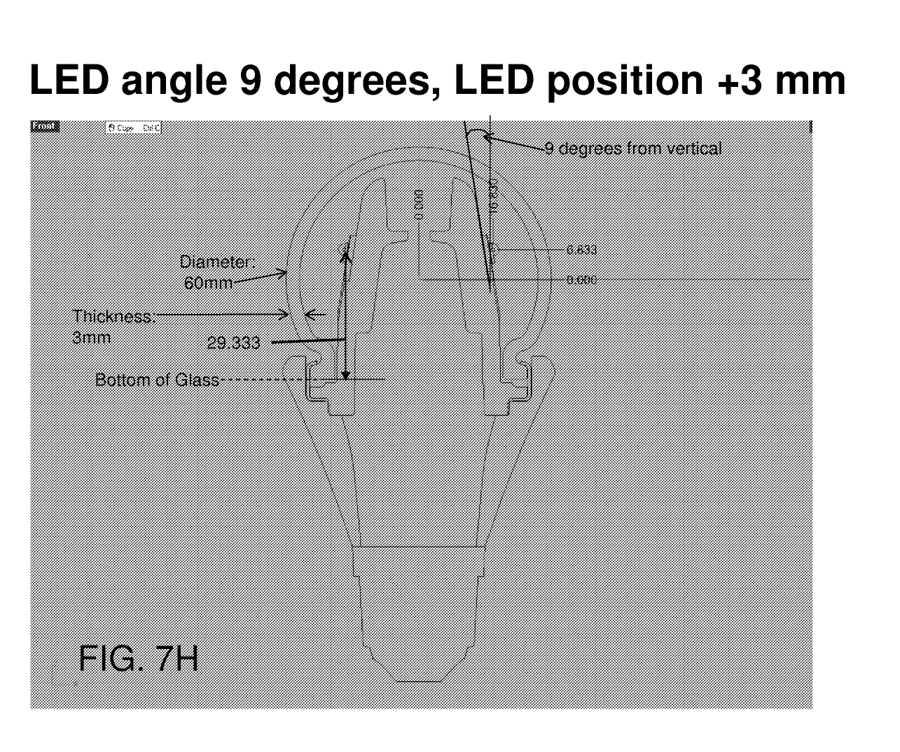

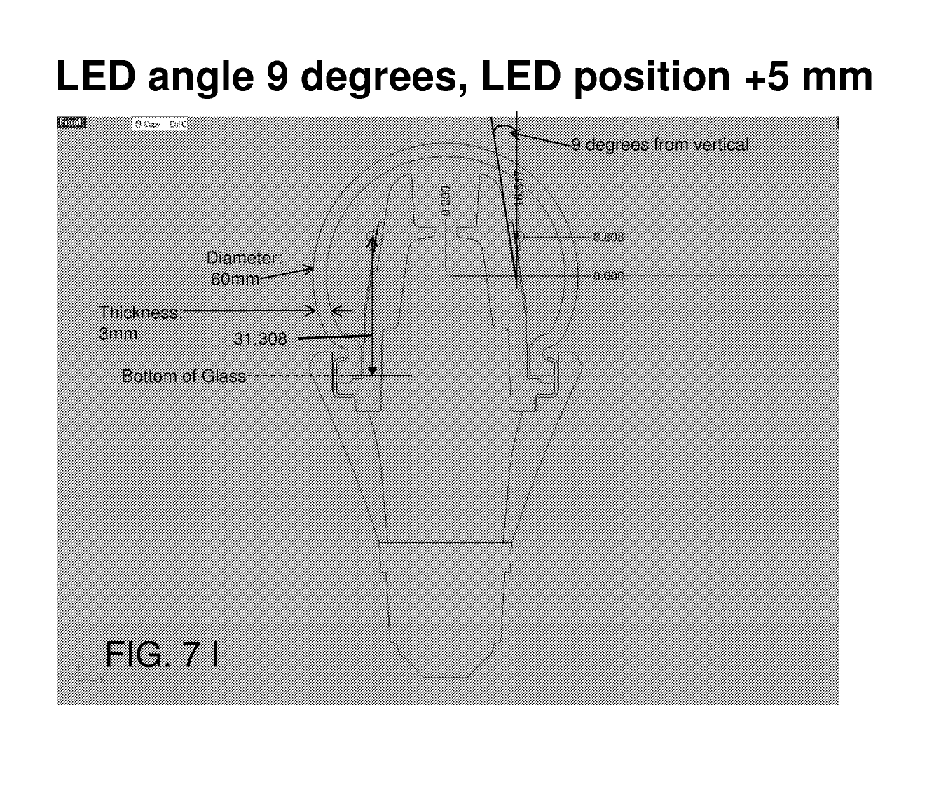

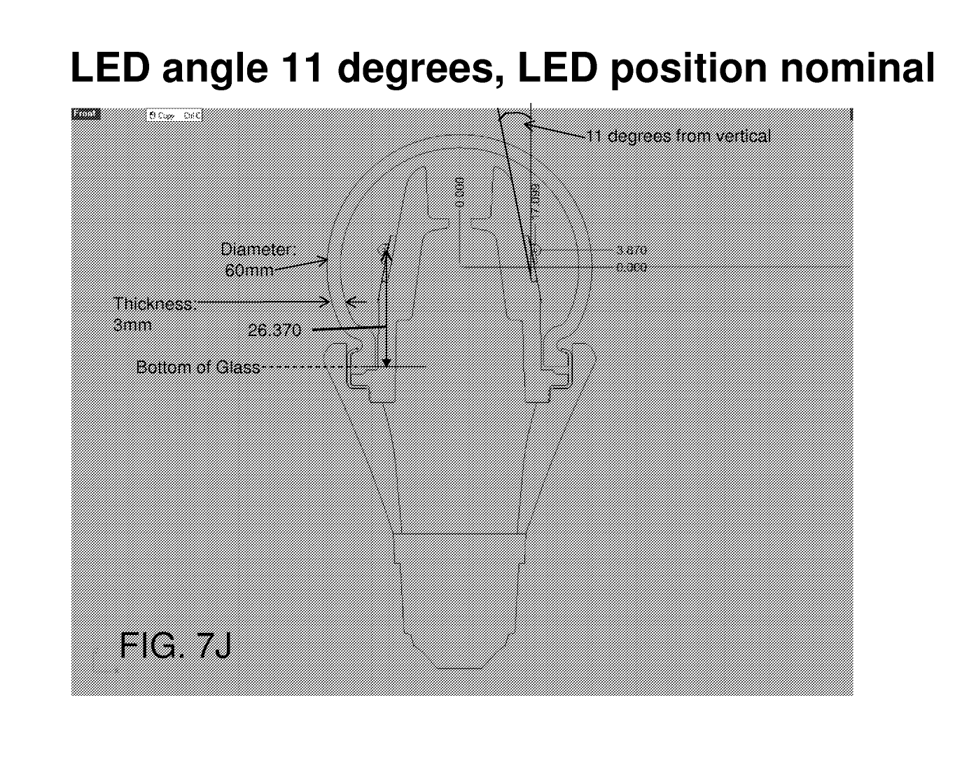

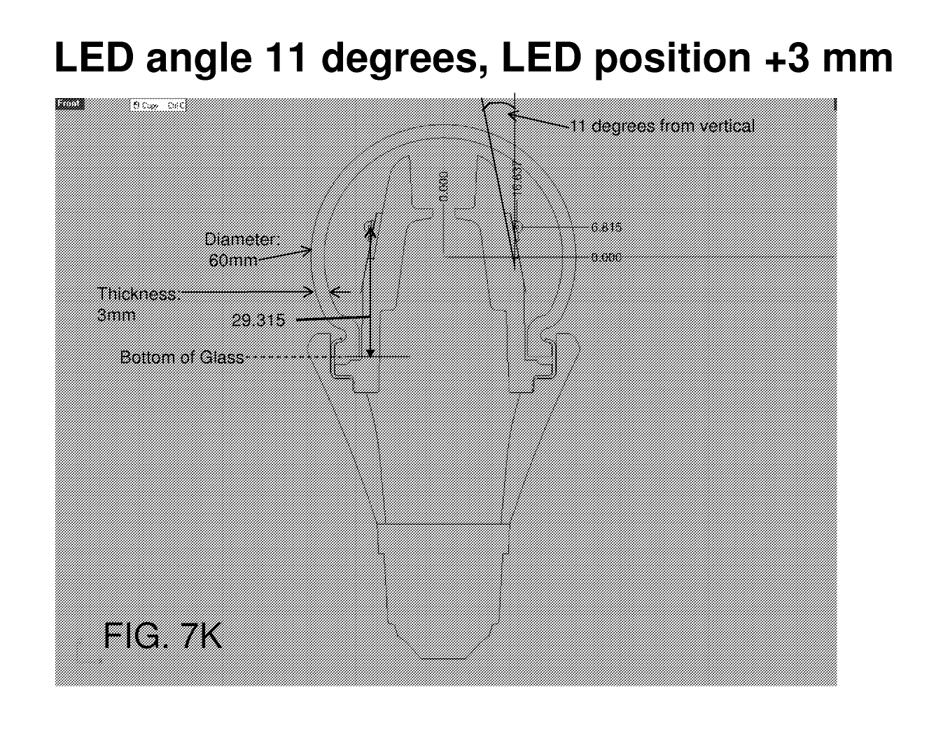

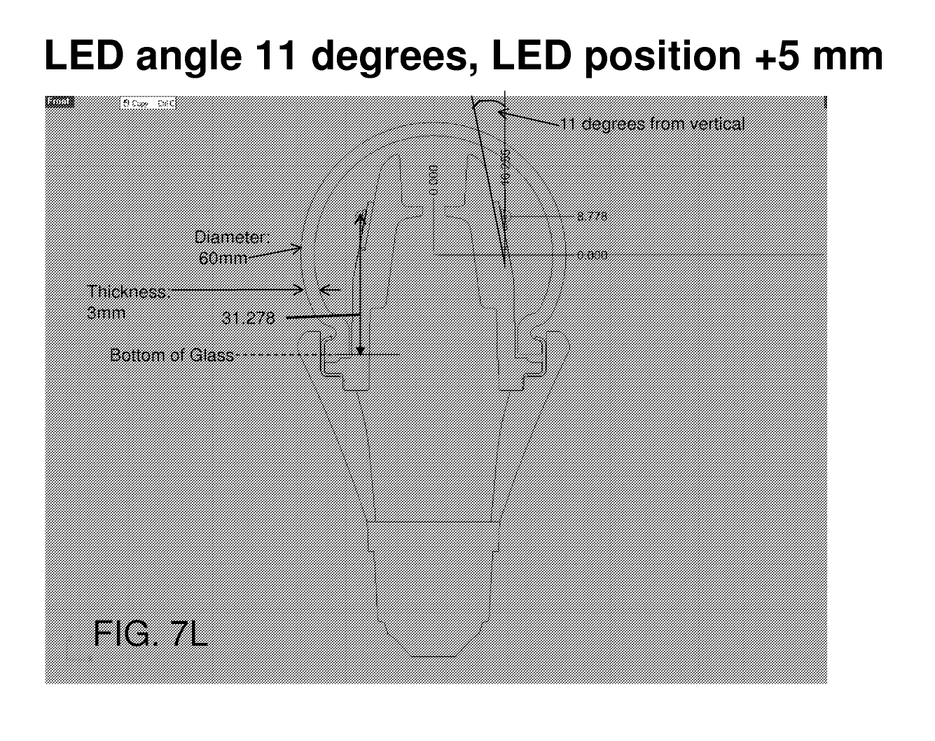

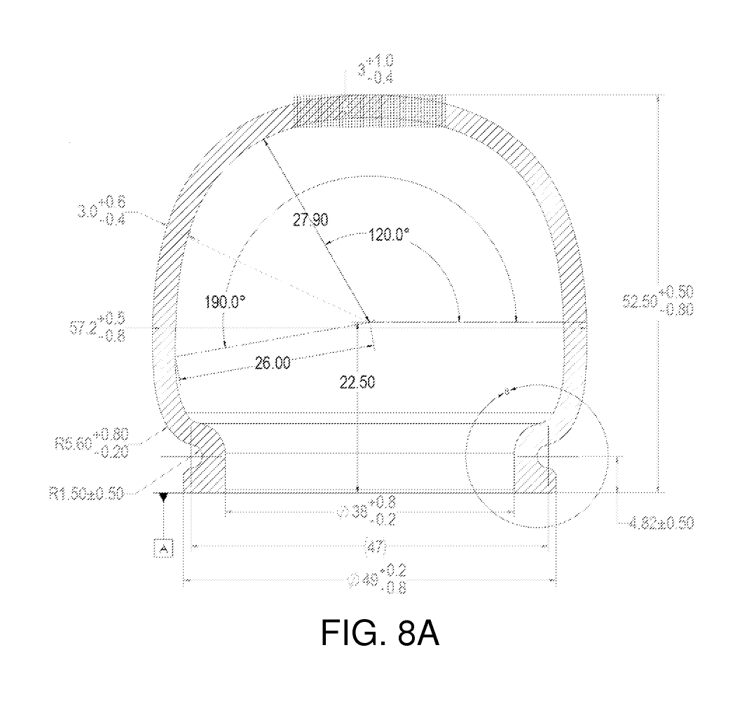

In the examples provided below, the profile shape is defined using two or more radial constraints. Specifically, the distance from the shell profile to the center of the shell is defined for two or more locations of the profile shape. As shown in FIGS. 8A-B, a shell profile having multiple distances from the shell edge to the center of the shell will also have multiple radii. In the present embodiment, a first radial constraint is obtained for a first portion of the profile shape, the first portion located between 0 and 40 degrees as measured from an apex of the shell. A second radial constraint is obtained for a second portion of the profile shape located between 40 and 90 degrees from the apex. A third radial constraint is calculated for a third portion of the profile shape located between 90 and 130 degrees from the apex. The profile shape is calculated based on the first, second, and third radial constraints.

In the present embodiment, a spline function is used to calculate a shell shape that satisfies the two or more radial constraints. In other embodiments, the two or more radial constraints may be specified by specifying two or more radii values, diameter values, shell width values, or the like. Using a parametric modeling tool such as SolidWorks, the two or more radial constraints can be specified using a variety of geometric constraints and blended using a spline or curve fitting function. Additional geometric constraints, such as congruency and tangency to a sealing flange on the shell, may also be used to satisfy other functional requirements of the shell.

With respect to operation 1206, multiple analyses may be conducted using various shell profile shapes to obtain multiple far-field intensity distributions. FIGS. 8A-B, discussed in more detail below, depict exemplary results of multiple optical analyses for simulated shells having different radii. To perform multiple analyses, the geometry of the shell and other parameters may be modified using the optical modeling tool (e.g., APEX) or re-imported into the optical modeling tool from another modeling software tool (e.g., SolidWorks solid modeler).

The results of the multiple optical analyses may be compared to calculate a bulb shape that results in a light-distribution profile that satisfies a uniformity criterion. As previously mentioned, the uniformity criterion may be based on the Energy Star specifications for light-distribution profile uniformity. In the example provided below with respect to FIGS. 8A-B, multiple analyses can be performed for simulated shells having different profile shapes. In this example, the shell profile is flattened near the apex and base of the shell different amounts to obtain multiple profile shapes of the simulated shell. The mean light intensity can be simulated for each of the profile shapes and a deviation from the mean can be computed. The profile shape of the shell can be computed, for example, by optimizing the deviation from mean for 0 for the radial constrains that define the profile shape. In the example provided in FIGS. 8A-B, flattening the profile shape near the apex of the shell (decreasing the distance from the shell edge to the shell center) increases the light intensity for regions near the apex of the LED bulb. Similarly, flattening the profile shape near the base of the shell increases the light intensity near the base of the shell.

In another implementation, multiple candidate configurations can be selected as having a deviation from the mean light intensity, over 0 degrees to 135 degrees, of less than a threshold (e.g., 20 percent). Any one of the selected configurations can be used to produce an LED bulb having a light-distribution profile that satisfies uniformity criteria. In some cases, the candidate with the most uniform light-distribution profile is selected as the optimum configuration.

In operation 1208, the results are stored in computer memory. In some cases, the profile shape calculated in operation 1206 is stored in computer-readable memory, including, RAM, hard drive storage media, optical storage media, or the like. In some cases, the results of at least one of the optical analysis performed in operation 1206, including one or more radial constraints, are stored in computer-readable memory. The stored results can be used to construct an LED bulb with a shell having a profile shape calculated in operation 1206. In some embodiments, the stored results can be used to produce an LED bulb having a predicted light-distribution profile that does not deviate more than 20 percent from mean over 0 degrees to 135 degrees as measured from an axis extending from the center of the shell to the apex of the shell.

FIGS. 8A-B depict exemplary simulated shells having a profile shape that can be used to produce an LED bulb having a light-distribution profile that satisfies uniformity criteria. For the examples provided below, the LEDs are positioned at a 9 degree angle and at a +3 mm position with respect to nominal.

For purposes of the analysis, the index of refraction for the thermally conductive liquid is 1.4015, the index of refraction for the shell is 1.52, and the shell is 3 mm thick. For purposes of the all the simulations provided herein, the simulations were normalized to 1 lumen per simulated LED. The optical properties of the base and support structures, including surface finish to simulate optical scattering were also taken into account. FIG. 13 depicts an exemplary bidirectional reflectance distribution function (BRDF) applied to the simulated support structures and the simulated base.

FIG. 8A depicts a shell profile having a distance from the center of the shell to the shell profile of 27.9 mm for a first portion of the shell located at approximately 30 degrees from the apex of the shell and a distance of 26 mm for a third portion of the shell located at approximately 100 degrees from the apex of the shell.

FIG. 8B depicts a shell profile having a distance from the center of the shell to the shell profile of 26.8 mm for a first portion of the shell located at approximately 30 degrees from the apex of the shell and a distance of approximately 26.3 mm for a third portion of the shell located at approximately 100 degrees from the apex of the shell.

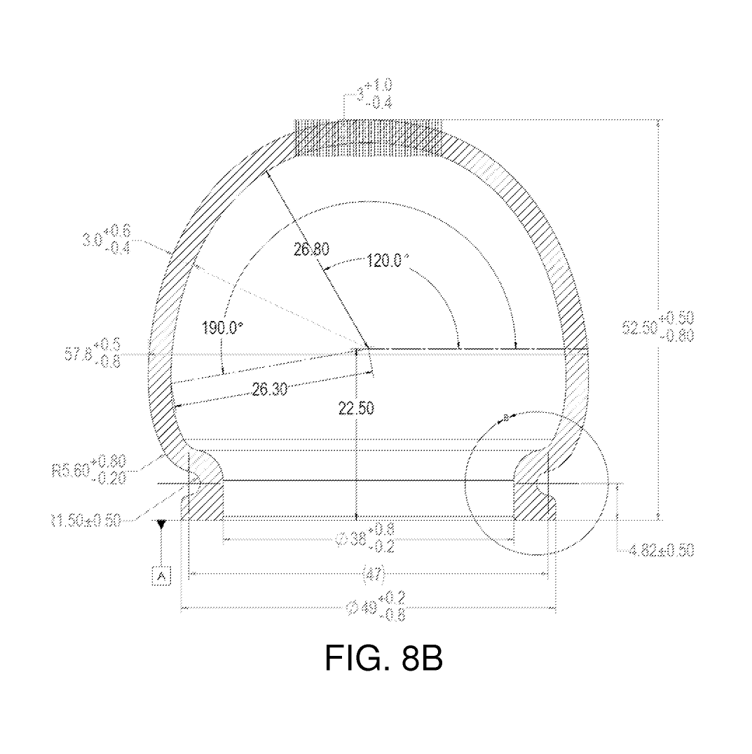

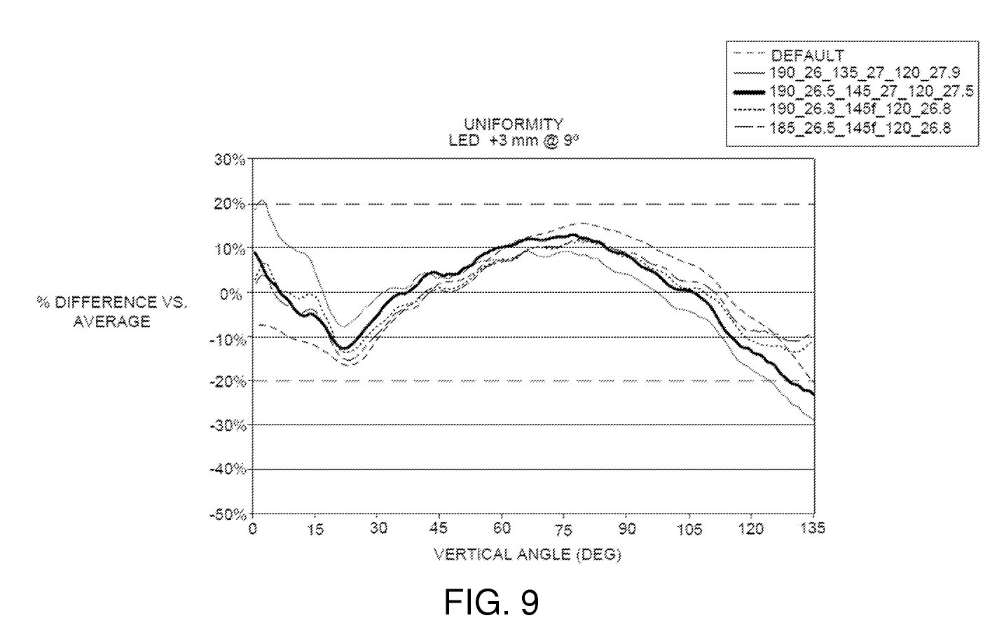

FIG. 9 depicts analysis results for a simulated shell having five different profile shapes. Specifically, FIG. 9 depicts an intensity distribution and intensity uniformity over angles of 0 to 135 from the apex of the shell.

FIG. 9 depicts results for a first profile shape having a uniform radius of 30 mm (“Default”). A second profile shape has a distance from the shell profile to the center of the shell of 26 mm at 100 degrees from the apex, a distance of 27 mm at 45 degrees from the apex, and a distance of 27.9 mm at 30 degrees from the apex (“190_{—}26_{—}135_{—}27_{—}120_{—}27.9”). A third profile shape has a distance from the shell profile to the center of the shell of 26.5 mm at 100 degrees from the apex, a distance of 27 mm at 55 degrees from the apex, and a distance of 27.5 mm at 30 degrees from the apex (“190_{—}26.5_{—}145_{—}27_{—}120_{—}27.5). A fourth profile shape has a distance from the shell profile to the center of the shell of 26.3 mm at 100 degrees from the apex and a distance of 26.8 mm at 30 degrees from the apex (“190_{—}26.3_{—}145f_{—}120_{—}26.8”). A fifth profile shape has a distance from the shell profile to the center of the shell of 26.5 mm at 95 degrees from the apex and a distance of 26.8 mm at 30 degrees from the apex (“185_{—}26.3_{—}145f_{—}120_{—}26.8”).

As shown in FIG. 9, the first, fourth, and fifth profile shapes have a predicted light-distribution profile that satisfies the Energy Star uniformity criteria. The fourth profile shape has a predicted light-distribution profile that is the most uniform of the five profile shapes. Either of the first, third, fourth, or fifth profile shapes can be used to produce an LED bulb having a light distribution profile that satisfies the Energy Start uniformity criteria.

### 3. Diffuser Band

Using a liquid-filled bulb as described above with respect to FIG. 1, the LEDs, thermally-conductive liquid, and shell form an optical system that can be configured to produce a desired light-distribution profile. In the examples described below, the location of a diffuser band is calculated to produce an LED bulb having a light-distribution profile that satisfies uniformity criteria.

As discussed above, an LED having a Lambertian distribution profile tends to produce the most light perpendicular to the face of the LED and less light as the angle from the face is increased. Previous methods discussed above with respect to FIGS. 3A and 3B divert light to the upper and lower portions of the LED bulb by calculating an LED angle, LED height, and profile bulb shape. In the example provided below, a diffuser band is used to disperse light near the middle region of the LED bulb to produce an LED bulb having a desired light-distribution profile. Specifically, the location of a diffuser band is calculated with respect to a plurality of LEDs to produce an LED bulb having a light-distribution profile that satisfies Energy Star uniformity criteria.

In some embodiments, the diffuser band may not improve the uniformity of the light-distribution profile, but may satisfy other design requirements. For example, a diffuser band may be used to reduce the appearance of point sources of light produced by the LEDs. In other embodiments, a diffuser band may be used to mask portions of the LED bulb as viewed from the outside. For example, it may be desirable that the LED components are not visible from the exterior of the bulb. A diffuser band may also be used to create a specialized lighting effect.

In the examples provided below, a diffuser band is a region of the shell that is treated to disperse light produced by the plurality of LEDs over a specified region of the shell to a greater degree than other regions of the shell. For purposes of this discussion, a diffuser band does not occupy a region that substantially covers the entire optical surface of the shell. In one embodiment, the diffuser band may be created by sandblasting a glass shell using various grit size. A grit size of, for example, 180, 220, 320, 400 grit may be used. In some cases, the shell may be coated on the inside or outside with a material that produces increased diffusion over the region. For example, the shell may be coated with a chemical-based or water-based paint that produces increased diffusion. In an alternative embodiment, the shell may also be etched using a chemical treatment to produce increased diffusion over a specified region.

FIG. 3C depicts an exemplary process 1300 for providing an LED bulb having a light-distribution profile that satisfies uniformity criteria by calculating the location of a diffuser band. Process 1300 can be used to calculate an optical configuration for an LED bulb having a predicted light-distribution profile that satisfies Energy Star uniformity requirements.

In operation 1302, optical properties of the shell and thermally conductive liquid are obtained. The optical properties may include, for example, the index of refraction and optical transmissivity of the shell and thermally conductive liquid. In addition, the index of reflection of optical coatings on the shell or other optical components may also be obtained.

In operation 1304, an optical simulation model is created. The optical simulation model simulates the optical and geometric configuration of the LED bulb relevant to an optical analysis of the LED bulb. In this example, the optical simulation model simulates the geometry and position of LED bulb components that are relevant to an optical analysis of the far-field intensity of light emitted by one or more LEDs. Examples of the creation of an optical simulation model are provided above with respect to operation 1104 of FIG. 3A.

In operation 1306, the location of a diffuser band on a simulated shell is calculated. In this example, the location of the diffuser band is calculated based on the optical simulation model created in operation 1304 and the optical properties obtained in operation 1302. Specifically, in this example, at least one optical analysis is conducted using the optical simulation model to obtain a far-field intensity distribution over a specified area of the simulate LED bulb. The optical analysis may include a ray-trace optical analysis that calculates the angle and intensity of a plurality of simulated light rays emitted by the one or more simulate LEDs. Light scattering, reflection, and absorption may also be computed as part of the optical analysis.

In the examples provided below, the location of the diffuser is defined with respect to a width and a location with respect to the plurality of the LEDs. The location may also be specified using angular values or other dimensional values with respect to the shell geometry.

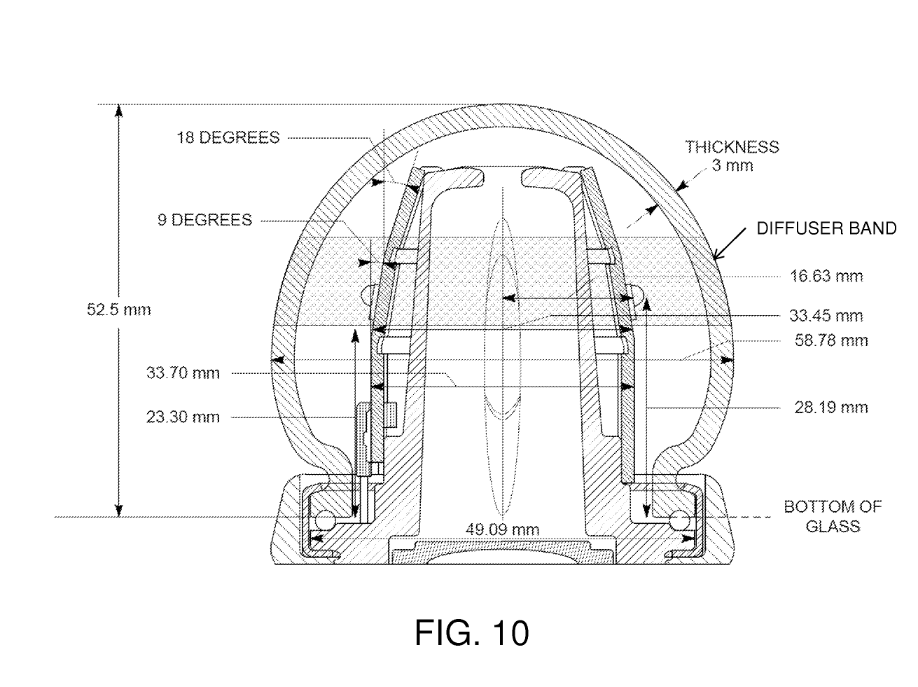

With respect to operation 1306, multiple analyses may be conducted using various shell profile shapes to obtain multiple far-field intensity distributions. FIG. 10, discussed in more detail below, depicts one exemplary result for a simulated diffuser band on a simulate shell. To perform multiple analyses, the geometry of diffuser band and other parameters may be modified using the optical modeling tool (e.g., APEX) or re-imported into the optical modeling tool from another modeling software tool (e.g., SolidWorks solid modeler).

The results of the multiple optical analyses may be compared to calculate a location of a diffuser band that results in a light-distribution profile that satisfies a uniformity criterion. As previously mentioned, the uniformity criterion may be based on the Energy Star specifications for light-distribution profile uniformity.

In operation 1308, the results are stored in computer memory. In some cases, the location of the diffuser band calculated in operation 1306 is stored in computer-readable memory, including, RAM, hard drive storage media, optical storage media, or the like. In some cases, the results of at least one of the optical analysis performed in operation 1306, including the other simulated bulb geometry, are stored in computer-readable memory. The stored results can be used to construct an LED bulb with a shell having diffuser band at a location calculated in operation 1306. In some embodiments, the stored results can be used to produce an LED bulb having a predicted light-distribution profile that does not deviate more than 20 percent from mean over 0 degrees to 135 degrees as measured from an axis extending from the center of the shell to the apex of the shell. In some embodiments, the stored results can be used to produce an LED bulb having a predicted light-distribution profile that does not deviate more than 18, 15, 14, or 11 percent from mean over 0 degrees to 135 degrees.

FIG. 10 depicts and LED bulb having an exemplary diffuser band that can be used to produce an LED bulb having a light-distribution profile that satisfies uniformity criteria. As shown in FIG. 10, the LEDs are positioned at a 9 degree angle and at a +3 mm position with respect to nominal.

For purposes of the analysis, the index of refraction for the thermally conductive liquid is 1.4015, the index of refraction for the shell is 1.52, and the shell is 3 mm thick. For purposes of the all the simulations provided herein, the simulations were normalized to 1 lumen per simulated LED. The optical properties of the base and support structures, including surface finish to simulate optical scattering were also taken into account. FIG. 13 depicts an exemplary bidirectional reflectance distribution function (BRDF) applied to the simulated support structures and the simulated base.

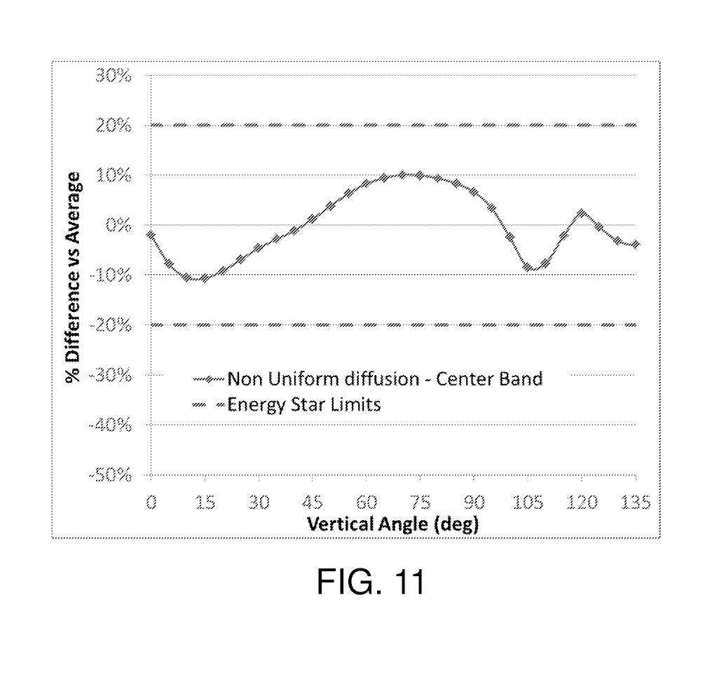

FIG. 11 depicts exemplary results for an LED bulb having a diffuser band that is located approximately 12.5 mm above and approximately 5.5 mm below the center of the plurality of LEDs. As shown in FIG. 11, an LED bulb having a diffuser band in this location has a predicted light-distribution profile uniformity of +/−11% from the mean intensity. Thus, a diffuser band in this location can be used to produce an LED bulb having a light distribution profile that satisfies the Energy Start uniformity criteria.

LED bulbs having a diffuser band in other locations may also have a predicted light-distribution profile that satisfies the Energy Start uniformity criteria. For example, LED bulbs having a diffuser band that is 5 mm to 15 mm above and 5 mm to 15 below the center of the plurality of LEDs may also be used to produce an LED bulb that satisfies Energy Star uniformity criteria. In other embodiments, the diffuser band may be located more than 15 mm above and more than 15 mm below the center of the plurality of LEDs. In other embodiments, the diffuser band may be located less than 5 mm above and less than 5 mm below the center of the plurality of LEDs.

### 4. Optimizing Light Distribution Based on Multiple Factors

As discussed above, the indices of refraction of the shell and thermally conductive liquid, the angle and position of the LEDs with respect to the shell, profile shape of the shell, and the location of a diffuser band all affect how the light emitted from the LED is diverted by the LED bulb. One or more of these parameters can be optimized to produce an LED bulb having a predicted light-distribution profile that satisfies uniformity criteria.

FIG. 3D depicts an exemplary process 1000 for providing an LED bulb having a light-distribution profile that satisfies uniformity criteria by calculating one or more of the following: the angle of at least one LED, the height of at least one LED, the profile shape of the shell, and the location of a diffuser band disposed on the shell. Process 1000 can be used to calculate an optical configuration for an LED bulb having a predicted light-distribution profile that satisfies Energy Star uniformity requirements.

In operation 1002, optical properties of the shell and thermally conductive liquid are obtained. The optical properties may include, for example, the index of refraction and optical transmissivity of the shell and thermally conductive liquid. In addition, the index of reflection of optical coatings on the shell or other optical components may also be obtained.

In operation 1004, an optical simulation model is created. The optical simulation model simulates the optical and geometric configuration of the LED bulb relevant to an optical analysis of the LED bulb. In this example, the optical simulation model simulates the geometry and position of LED bulb components that are relevant to an optical analysis of the far-field intensity of light emitted by one or more LEDs. Examples of the creation of an optical simulation model are provided above with respect to operation 1104 of FIG. 3A.

In operation 1006, one or more of the following values are calculated: the angle of at least one LED, the height of at least one LED, the profile shape of the shell, and the location of a diffuser band disposed on the shell. In this example, the one or more values are calculated based on the optical simulation model created in operation 1004 and the optical properties obtained in operation 1002. Specifically, in this example, at least one optical analysis is conducted using the optical simulation model to obtain a far-field intensity distribution over a specified area of the simulate LED bulb. The optical analysis may include a ray-trace optical analysis that calculates the angle and intensity of a plurality of simulated light rays emitted by the one or more simulate LEDs. Light scattering, reflection, and absorption may also computed as part of the optical analysis.

With respect to operation 1006, multiple analyses may be conducted by varying one or more of the following: angle and height of the LEDs, profile shape of the shell, and location of the diffuser band. The results of the multiple optical analyses may be compared to calculate values that result in a light-distribution profile that satisfies a uniformity criterion. As previously mentioned, the uniformity criterion may be based on the Energy Star specifications for light-distribution profile uniformity.

In operation 1008, the results are stored in computer memory. In some cases, one or more of: the angle and height of the LEDs, the profile shape of the shell, or the location of the diffuser band calculated in operation 1006 is stored in computer-readable memory, including, RAM, hard drive storage media, optical storage media, or the like. In some cases, the results of at least one of the optical analysis performed in operation 1006, including the other simulated bulb geometry, are stored in computer-readable memory. The stored results can be used to construct an LED bulb based on values calculated in operation 1006. In some embodiments, the stored results can be used to produce an LED bulb having a predicted light-distribution profile that does not deviate more than 20 percent from mean over 0 degrees to 135 degrees as measured from an axis extending from the center of the shell to the apex of the shell. In some embodiments, the stored results can be used to produce an LED bulb having a predicted light-distribution profile that does not deviate more than 18, 15, 14, or 11 percent from mean over 0 degrees to 135 degrees.

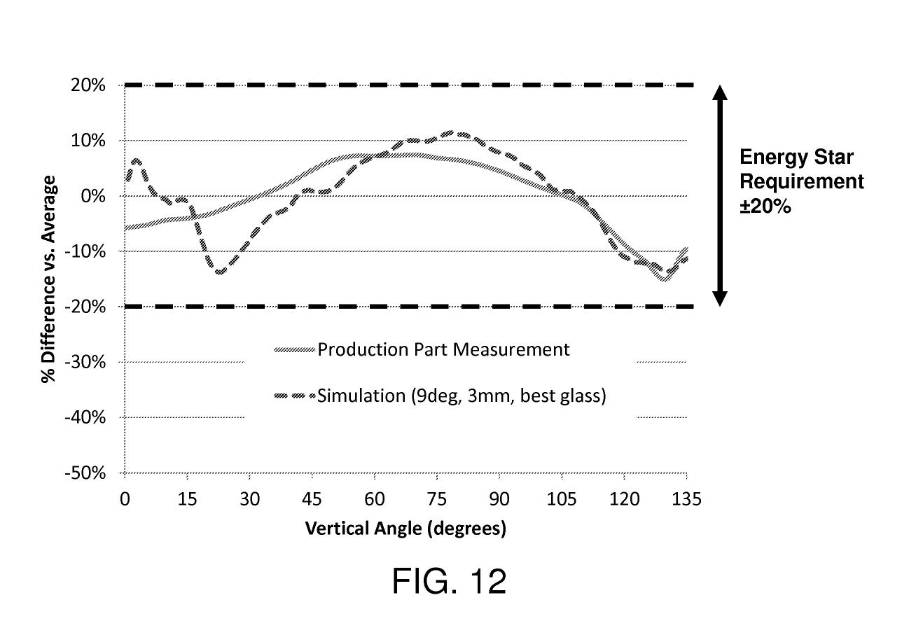

FIG. 12 depicts results from an analysis of an exemplary simulated LED bulb as compared to measured light distribution for an actual LED bulb. The simulated LED bulb has a plurality of LEDs at a height of +3 mm from nominal and an angle of 9 degrees. The simulated LED bulb also has a simulated shell having a distance from the center of the shell to the shell profile of 26.8 mm for a first portion of the shell located at approximately 30 degrees from the apex of the shell and a distance of approximately 26.3 mm for a third portion of the shell located at approximately 100 degrees from the apex of the shell. The actual LED bulb has a plurality of LEDs at a location that corresponds to the simulated LED and a shell with a profile shape that corresponds to the profile shape of the simulated shell.

For purposes of the analysis, the index of refraction for the thermally conductive liquid is 1.4015, the index of refraction for the shell is 1.52, and the shell is 3 mm thick. The simulation was normalized to 1 lumen per simulated LED. The optical properties of the base and support structures, including surface finish to simulate optical scattering were also taken into account. FIG. 13 depicts an exemplary bidirectional reflectance distribution function (BRDF) applied to the simulated support structures and the simulated base.

As shown in FIG. 12, the deviation from mean for the predicted light-distribution profile of the simulate LED bulb roughly corresponds to the deviation from mean for the measured light-distribution of the actual LED bulb. Both the simulated and actual LED bulb have a light-distribution profile that does not deviate more than 20 percent from mean over 0 degrees to 135 degrees. In some cases, the actual LED is able to produce light having a light intensity distribution uniformity of +14% and −15% deviation as compared to a mean light intensity over 0 to 135 degrees.

Although a feature may appear to be described in connection with a particular embodiment, one skilled in the art would recognize that various features of the described embodiments may be combined. Moreover, aspects described in connection with an embodiment may stand alone.

We claim:

1. A computer-implemented method for providing a light emitting diode (LED) bulb having a light-distribution profile that satisfies uniformity criteria, the method comprising:
obtaining an index of refraction and profile shape of a simulated shell;
obtaining an index of refraction of a simulated thermally conductive liquid;
creating an optical simulation model of the LED bulb, the optical simulation model having a plurality of simulated LEDs disposed within the simulated shell and the simulated thermally conductive liquid disposed between the plurality of simulated LEDs and the interior of the simulated shell;
calculating one of an angle and a height of at least one simulated LED of the plurality of simulated LEDs with respect to the shell based on:
the optical simulation model;
the index of refraction and the profile shape of the simulated shell; and
the index of refraction of the thermally conductive liquid,
wherein, the angle and the height results in a predicted light-distribution profile that varies 20 percent or less with respect to mean light intensity over 0 degrees to 135 degrees as measured from an axis extending from the center of the simulated shell to the apex of the simulated shell;
storing the calculated angle and height of the first simulated LED.

2. The computer-implemented method of claim 1, wherein the optical simulation model is adapted to perform a ray-trace optical analysis for simulated light emitted from at least one of the plurality of simulated LEDs.

3. A method of making a light emitting diode (LED) bulb having a light-distribution profile that satisfies uniformity criteria, the method comprising:
obtaining a base;
obtaining a shell having an index of refraction and a profile shape;
calculating an angle and height of at least one LED of a plurality of LEDs based the index of refraction and the profile shape of the shell, and an index of refraction of a thermally conductive liquid to be disposed within the shell and between the plurality of LEDs and the shell,
wherein the angle and height result in a predicted light-distribution profile that varies 20 percent or less with respect to mean light intensity over 0 degrees to 135 degrees as measured from an axis extending from the center of the shell to the apex of the shell;
positioning the plurality of LEDs within the shell at the calculated angle and the calculated height;
attaching the shell to the base; and
filling the shell with the thermally conductive liquid.

4. A liquid-filled light emitting diode (LED) bulb comprising:
a base;
a shell connected to the base;
a plurality of LEDs attached to the base and disposed within the shell; and
a thermally conductive liquid held within the shell and disposed between the plurality of LEDs and the shell,
wherein the plurality of LEDs are positioned between 3.5 and 10 millimeters from the center of the shell, and are positioned at an angle between 4 and 12 degrees from a central axis of the shell, and
the LED bulb has a predicted light-distribution profile that varies 20 percent or less with respect to mean light intensity over 0 degrees to 135 degrees as measured from an apex of the shell.

5. A computer-implemented method for providing a light emitting diode (LED) bulb having a light-distribution profile that satisfies uniformity criteria, the method comprising:
obtaining an index of refraction of a simulated shell;
obtaining an index of refraction of a simulated thermally conductive liquid;
obtaining an angle and a height of at least one simulated LED of the plurality of simulated LEDs with respect to the simulated shell;
creating an optical simulation model of the LED bulb, the optical simulation model having a plurality of simulated LEDs disposed within the simulated shell and the simulated thermally conductive liquid disposed between the plurality of simulated LEDs and the interior of the simulated shell;
calculating a profile shape of the simulated shell, the profile shape having at least two radii, the calculation based on:
the optical simulation model,
the angle and height of the of at least one simulated LED,
the index of refraction of the simulated shell, and
the index of refraction of the thermally conductive liquid,
wherein, the profile shape results in a predicted light-distribution profile that varies 20 percent or less with respect to mean light intensity over 0 degrees to 135 degrees as measured from an axis extending from the center of the simulated shell to the apex of the simulated shell;
storing the calculated profile shape of the simulated shell.

6. The computer-implemented method of claim 5, wherein calculating the profile shape of the simulated shell includes:
obtaining a first radial constraint for a first portion of the profile shape, the first portion located between 0 and 40 degrees as measured from an apex of the simulated shell; and
obtaining a second radial constraint for a second portion of the profile shape, the second portion located between 40 and 130 degrees from the apex of the simulated shell;
calculating the profile shape based on the first and second radial constraint.

7. The method of claim 5, wherein calculating the profile shape of the simulated shell includes:
obtaining a first radial constraint for a first portion of the profile shape, the first portion located between 0 and 40 degrees as measured from an apex of the simulated shell;
obtaining a second radial constraint for a second portion of the profile shape, the second portion located between 40 and 90 degrees from the apex of the simulated shell;
obtaining a third radial constraint for a third portion of the profile shape, the third portion located between 90 and 130 degrees from the apex of the simulated shell; and
calculating the profile shape based on the first, second, and third radial constraint.

8. A method of making a light emitting diode (LED) bulb having a light-distribution profile that satisfies uniformity criteria, the method comprising:
obtaining a base;
calculating a profile shape of a shell having at least two radii based on:
an index of refraction of the shell,
an index of refraction of a simulated thermally conductive liquid to be placed in the shell,
an angle and a height of at least one simulated LED of a plurality of simulated LEDs to be disposed within the shell,
wherein the profile shape of the shell results in a predicted light-distribution profile that varies 20 percent or less with respect to mean light intensity over 0 degrees to 135 degrees as measured from an apex of the shell;
obtaining a shell having the calculated profile shape;
positioning the plurality of LEDs within the shell;
attaching the shell to the base; and
filling the shell with the thermally conductive liquid.

9. A liquid-filled light emitting diode (LED) bulb comprising:
a base;
a shell connected to the base;
a plurality of LEDs attached to the base and disposed within the shell; and
a thermally conductive liquid held within the shell,
wherein the shell has a profile shape having:
a first distance to the center of the bulb for a first portion of the profile shape, the first portion located between 0 and 40 degrees as measured from an apex of the shell,
a second distance to the center of the shell for a second portion of the profile shape, the second portion located between 40 and 130 degrees from the apex of the shell,
wherein the first and second distances are different distances, and
wherein the LED bulb has a predicted light-distribution profile that varies 20 percent or less with respect to mean light intensity over 0 degrees to 135 degrees as measured from an axis extending from the center of the shell to the apex of the shell.

10. The LED bulb of claim 9, wherein the first distance is approximately 27.5 mm and the second distance is approximately 26.5 mm.

11. The LED bulb of claim 9, wherein the first distance is approximately 26.8 mm and the second distance is approximately 26.3 mm.

12. The LED bulb of claim 9, wherein the first distance is approximately 26.8 mm and the second distance is approximately 26.5 mm.

13. A computer-implemented method for providing a light emitting diode (LED) bulb having a light-distribution profile that satisfies uniformity criteria, the method comprising:
obtaining an index of refraction and profile shape of a simulated shell;
obtaining an index of refraction of a simulated thermally conductive liquid;
creating an optical simulation model of the LED bulb, the optical simulation model having a plurality of simulated LEDs disposed within the simulated shell and the simulated thermally conductive liquid disposed between the plurality of simulated LEDs and the interior of the simulated shell;
calculating a location of a simulated diffuser band disposed on the simulated shell based on:
the optical simulation model;
the index of refraction and the profile shape of the simulated shell; and
the index of refraction of the thermally conductive liquid,
wherein, the location of the simulated diffuser band results in a predicted light-distribution profile that varies 20 percent or less with respect to mean light intensity over 0 degrees to 135 degrees as measured from an axis extending from the center of the simulated shell to the apex of the simulated shell;
storing the calculated location of the simulated diffuser band.

14. A method of making a light emitting diode (LED) bulb having a light-distribution profile that satisfies uniformity criteria, the method comprising:
obtaining a base;
obtaining a shell having an index of refraction and a profile shape;
calculating a location of a diffuser band based the index of refraction and the profile shape of the shell, and an index of refraction of a thermally conductive liquid to be disposed within the shell and between the plurality of LEDs and the shell,
wherein the location of the diffuser band result in a predicted light-distribution profile that varies 20 percent or less with respect to mean light intensity over 0 degrees to 135 degrees as measured from an axis extending from the center of the shell to the apex of the shell;
providing a diffuser band disposed on the shell at the calculated location;
attaching the shell to the base; and
filling the shell with the thermally conductive liquid.

15. A liquid-filled light emitting diode (LED) bulb comprising:
a base;
a shell connected to the base;
a plurality of LEDs attached to the base and disposed within the shell; and
a diffuser band disposed on the shell at within 10 mm above and 10 mm below the center of the plurality of LEDs; and
a thermally conductive liquid held within the shell and disposed between the plurality of LEDs and the shell,
wherein the LED bulb has a predicted light-distribution profile that varies 20 percent or less with respect to mean light intensity over 0 degrees to 135 degrees as measured from an axis extending from the center of the shell to the apex of the shell.

16. A computer-implemented method for providing a light emitting diode (LED) bulb having a light-distribution profile that satisfies uniformity criteria, the method comprising:
obtaining an index of refraction and profile shape of a simulated shell;
obtaining an index of refraction of a simulated thermally conductive liquid;
creating an optical simulation model of an LED bulb, the optical simulation model having a plurality of simulated LEDs disposed within the simulated shell and the simulated thermally conductive liquid disposed between the plurality of simulated LEDs and the interior of the simulated shell;
calculating one or more of:
an angle and a height of at least one simulated LED of the plurality of simulated LEDs with respect to the shell,
a profile shape of the simulated shell, the profile shape having at least two radii, and
a location of a diffuser band,
the calculation based on:
the optical simulation model;
the index of refraction of the simulated shell; and
the index of refraction of the thermally conductive liquid,
wherein, the calculation results in a predicted light-distribution profile that varies 20 percent or less with respect to mean light intensity over 0 degrees to 135 degrees as measured from an axis extending from the center of the simulated shell to the apex of the simulated shell;
storing the results of the calculation.

17. A liquid-filled light emitting diode (LED) bulb comprising:
a base;
a shell connected to the base;
a plurality of LEDs attached to the base and disposed within the shell; and
a thermally conductive liquid held within the shell and disposed between the plurality of LEDs and the shell,
wherein the plurality of LEDs are positioned approximately 9 millimeters from the center of the shell, and are positioned at an angle approximately 11 degrees from a central axis of the shell,
the shell has a profile shape having:
a first distance of approximately 26.8 millimeters to the center of the bulb for a first portion of the profile shape, the first portion located at approximately 30 degrees as measured from an apex of the shell,
a second distance of approximately 26.3 millimeters to the center of the shell for a second portion of the profile shape, the second portion located at approximately 100 degrees from the apex of the shell, and
the LED bulb has a predicted light-distribution profile that varies 20 percent or less with respect to mean light intensity over 0 degrees to 135 degrees as measured from an axis extending from the center of the shell to the apex of the shell.
